(19) United States
(12) Patent Application Publication
(10) Pub. No.: US 2026/0346511 A1
(43) Pub. Date: Nov. 5, 2026

(54) THREE-DIMENSIONAL NETWORKS OF NANOMATERIALS

(71) Applicant: CARNEGIE MELLON UNIVERSITY, Pittsburgh, PA (US)

(72) Inventors: Burak O. OZDOGANLAR, Pittsburgh, PA (US); Rahul PANAT, Pittsburgh, PA (US); Mert ARSLANOGLU, Pittsburgh, PA (US); Bin YUAN, Pittsburgh, PA (US)

(21) Appl. No.: 19/484,840

(22) PCT Filed: May 20, 2024
(86) PCT No.: PCT/US2024/030282

§ 371 Date: Nov. 14, 2025

Related U.S. Application Data
(60) Provisional application No. 63/467,849, filed on May 19, 2023.

(51) Int. Cl. B29C 39/38; B29C 39/42; B29K 105/00

(52) U.S. Cl. CPC B29C 39/38; B29C 39/42; B29K 2105/0073; B29K 2995/0005

(57) ABSTRACT

Internally-coated three-dimensional materials including a porous scaffold having an internal pore system including internal pores and interconnected interior channels in open communication with an exterior surface of the porous scaffold, and a functional internal conformal coating including OD materials, 1D materials, and/or 2D materials in contact with interior surfaces of the internal pores and the interconnected interior channels, and the coating may be characterized by an interconnected three-dimensional network that is electrically conductive and/or electrochemically active. Methods of making and using the materials are also described.

### CROSS-REFERENCE TO RELATED APPLICATIONS

This application National Stage of PCT/US2024/030282 entitled THREE-DIMENSIONAL NETWORKS OF NANOMATERIALS, filed on May 20, 2024, in which, claims the benefit of U.S. Provisional Application No. 63/467,849, filed May 19, 2023, the entire contents of which is incorporated herein by reference.

### FIELD

The present disclosure generally relates to nanomaterials (such as atomically thin 2D nanomaterials or ID nanomaterials or OD nanoparticles) and methods of arranging the same in three-dimensional space and their applications.

### BACKGROUND

Nanomaterials may exhibit exceptional properties, promising significant impact in applications such as energy storage, catalysis, and energy conversion, for example. Such nanomaterials may comprise of atomically thin two-dimensional (2D) materials, such as MXenes (titanium carbides) or graphene, one-dimensional (ID) materials, such as carbon nanotubes, and zero-dimensional (OD) materials, such as metal or ceramic nanoparticles. A major barrier to the widespread use of such materials may be the lack of methods for assembling them in three-dimensional (3D) space without significant restacking, which degrades their performance. Accordingly, more efficient and/or cost-effective arrangement of nanomaterials in three-dimensional (3D) space as well as methods of making and using the same may be desirable.

### SUMMARY

This disclosure is directed to more efficient and/or cost-effective arrangement of nanomaterials as well as methods of making and using the same.

This disclosure is directed to methods for assembling various types of nanomaterials in three-dimensional (3D) space such that the high surface area of the nanostructures may be available for reaction with the analytes in a device. The 3D network of nanomaterials may be formed on a porous backbone of ceramics (e.g., silica, alumina, calcium carbonate, etc.), metals (e.g., nickel, copper, etc.), polymers (e.g., polystyrene), or various forms of carbon (e.g., carbon black), having interconnected and controlled porosity. The backbone may dictate the network's 3D architecture while providing mechanical strength, gas/liquid permeability, and other beneficial properties. Freeze casting may be used to fabricate the backbone with open pores and controlled porosity. Next, capillary flow may be used to infiltrate the 2D, ID, or OD nanomaterials into the backbone from a dispersion. The system may be then dried such that the dynamics of drying conformally coats the nanomaterials on the pore walls, creating an interconnected 3D-nanomaterial network. For example, 2D MXenes coated on the internal pores (i.e., interior surfaces) of porous silica ceramic (thus forming a 3D network) via the approach according to this disclosure. The fabrication approach may be reproducible. Although ceramic materials, such as silica, may be nonconductive, the MXene-infiltrated porous silica (MX-PS) system may be highly conductive (e.g., 340 S/m). The electrical conductivity of such systems (e.g. MX-PS) may be controlled by the porosity distribution, conductive material concentration, and the number of infiltration cycles. Sandwich-type supercapacitors with MX-PS electrodes are shown to produce excellent areal capacitance (7.24 F cm-²) and energy density (0.32 mWh cm-²) with only 6% added MXene mass. This approach of creating 3D architectures of nanomaterials may significantly impact many engineering applications.

### BRIEF DESCRIPTION OF THE FIGURES

The compositions, systems, and processes described herein may be better understood by considering the following description in conjunction with the accompanying drawings; it being understood that this disclosure is not limited to the accompanying drawings.

FIG. 1 shows an example of three-dimensional network of nanomaterials. Specifically, MXene-infiltrated porous silica (MX-PS) system is illustrated. a) Preparation of silica discs with unidirectional porosity via freeze casting. The arrows represent the solidification direction and the main pore orientation. The SEM images show the horizontal (top) and vertical (bottom) cross-sections of the fabricated porous samples (scale bar=100 μm). b) A MXene infiltrated porous silica sample with a zoomed in 3D figure showing the thin-layer coating of internal pore surfaces by MXene flakes while preserving the structural porosity. A high-magnification back-scattered Scanning Electron Micrograph (SEM) of an infiltrated sample shows the thin-layer MXene coating (scale bar=10 μm).
c) MXene dispersion prepared using the minimally intensive layer delamination (MILD) method. d) The hydrodynamic diameter distribution of 2D ThC2Tx nanosheets for the prepared MXene dispersion. A solid model of the dispersed 2D flakes is given in the inset. e) Transmission Electron Micrograph (TEM) showing the structure and the size of a single-layer ThC2Tx nanosheet with arrows indicating its periphery. False coloring is used to help with visualization. f) Thermogravimetric analysis (TGA) results for the remaining mass of MXene dispersion as a function of temperature. The mass value at 200 °C is used for calculating the MXene concentration of dispersions.

FIG. 2 shows an experimental verification of the MXene infiltration process in freeze-cast silica shown in FIG. 1. a) An SEM image of a longitudinal cross-section of a rectangular sample used in the electrical conductivity measurements. The area labeled by the dashed rectangle indicates the boundaries of the analyzed cross-section. The schematic on the left illustrates the cross-sectioning process. b) Pairs of SEM images and Energy Dispersive X-ray Spectroscopy (EDX) maps at the locations denoted in (a), confirming that MXene films exhibit a thin conformal morphology along the pore surfaces and the pore access is not blocked. In EDX maps, the dark gray color represents Ti (i.e., ThC2Tx MXene) and the light gray color is linked to Si (i.e., SiO2). Scale bars in (a) and (b):t 500 μm and 10 μm, respectively.

FIG. 3 shows the electrical conductivity results of MXene infiltrated porous silica (MX-PS).
a) Effects of the MXene concentration and the number of infiltration cycles on electrical conductivity of MX-PS samples (Left: single infiltration experiments, dispersions with MXene concentration of 45, 90, 135, and 180 mg/mL; Right: multiple infiltration with 180 mg/mL MXene). b) Schematics showing the pore orientations of backbone: top-longitudinal porosity, as denoted by arrows, aligned with the direction of electrical measurements; bottom-lateral porosity, as denoted by arrows, perpendicular to the direction of electrical measurements, c) The effect of storage time on electrical conductivity for four separate MXene concentration levels:—180 mg/mL,—135 mg/mL,—90 mg/mL,—45 mg/mL. In (a) and (c), the results of three repetitions are reported for each data point. d) Electrical conductivity as a function of pore orientation:—longitudinal pore orientation;—lateral pore orientation.

FIG. 4 shows the use of MX-PS system as a supercapacitor. a) Schematic of the sandwich-type supercapacitor structure. b) CV curves for the MX-PS supercapacitor at different scan rates. c) Galvanostatic charge-discharge curves for the MX-PS supercapacitor at different current densities. d) Nyquist plot (EIS) showing the impedance of the MX-PS supercapacitor. The inset gives a detailed view of the high-frequency range. e) Schematic illustration showing the increased active zone due to the presence of MXene on pore surfaces. f) Tunability of the areal (left y-axis) and gravimetric (right y-axis) capacitance of the assembled supercapacitors by changing the porosity (bottom x-axis) and pore orientation (top x-axis) of freeze-cast silica backbones of the MX-PS electrodes. The circular sketches in each column represent the pore orientation from top-view of the electrodes: longitudinal pore orientation-out-of-plane pores; lateral pore orientation-in-plane pores.

FIG. 5 shows the comparison of our results with the literature and additional device configurations. a,b) Areal capacitance comparison of MX-PS supercapacitors with the values of previous MXene-based studies with various mass loadings of active materials from the literature (e.g., 3D Na-MX, MX/WOx, MX/PANI, MX/SA-5, MX Aerogel, 3DP MX, Extruded MX, MX/MnO2, and MX Clay.). The diagonal dashed lines in (a) represent areal capacitance per active mass loading, i.e., utilization. c) Area-normalized Ragone plot comparing the energy density and power density of MX-PS supercapacitors (this work) with several sandwich-type supercapacitors from the literature (e.g., symmetric TDVW-9, symmetric MX/MPFs-^{6:1}, asymmetric MX/Fe-15%//MnO2/CC, asymmetric Ti3C2 MX Aerogel II ESCNF, and symmetric 3D Na-MX). d) Optical photo of a yellow/orange LED powered by five serially connected MX-PS supercapacitors with longitudinal porosity. (MXene concentration=180 mg/mL). e) Schematic of the stacked cells fabricated for demonstration of scalability. f) Optical images of the stacked cells in the form of a pouch cell. g) CV curves of the single MX-PS supercapacitor and pouch cell in (f) at a scan rate of 10 mV s-¹. h) GCD curves of the single MX-PS supercapacitor and pouch cell in (f) at a current density of 2 mA cm-². The Nyquist and Bode plots of the pouch cell in comparison with the single cell is shown in Figure Sl5.

FIG. 8A-D: The microstructure of porous silica, fabricated via unidirectional freeze casting of a camphene-based slurry, used in this study. The SEM images show the pore morphology of the freeze-cast scaffold in (a) horizontal cross-section, which is perpendicular to the freezing direction, and (b) vertical cross-section, which is along the freezing direction, demonstrating isotropic and anisotropic pore morphologies, respectively. The main orientation of the elongated dendrites is parallel to the freezing direction. Scale bars represent 500 μm. (c) The size distributions for the equivalent diameter in the horizontal cross-section and for the maximum feret diameter in the vertical cross-sections. The parameters for the fitted Weibull distributions are given next to the distributions.
(d) The pore orientation distributions in the horizontal (top) and vertical (bottom) cross-sections. The data clearly shows the dominant pore alignment along the cooling direction (Z) in the vertical cross-sections. The presented cross-sections and data correspond to samples with 60% porosity. The silica powder of d50=400 nm was used in the initial slurry. For the directional freezing, cooling temperature was −5 °C.

FIG. 9A-B: (a) SEM images with 140×2500×, 5000×, and 20000× magnifications (from top to bottom) on the cross-section perpendicular to freezing direction. (b) EDX element maps on the highest magnification image in a) to verify the selective coating process.

FIG. 10A-D: Morphology of the MXene coating on porous silica backbone. (a) Conformal morphology of MXene coating shown with a high magnification SEM image and corresponding EDX maps for Si and Ti elements, representing silica and MXene, respectively. (b) Effect of inherent roughness of silica backbone on the morphology of MXene coating, creating protrusions. A simple schematic is also added. (c, d) High magnification SEM images to represent morphology of MXene coating. Dashed lines in (c) and (d) represent the out-of-plane edges of MXene coating, highlighting the conformal 3D MXene structure.

FIG. 11A-D: Effects of (a) MXene concentration in single infiltration experiments, and (b, c) number of infiltration cycles in multiple infiltration experiments on electrical conductivity of MX-PS, in linear axes. (d) Effect of infiltration duration, i.e., the duration porous silica samples are kept submerged inside MXene dispersions for, on electrical conductivity of MX-PS. The MXene concentration of infiltrant is (b) 180 mg/mL, (c) 90 mg/mL.

FIG. 12A-F: Qualitative assessment of infiltration depth using large cuboid porous silica samples with dimensions of 8 mm×8 mm×10 mm. (a-c) Cross section of a MX-PS sample with single MXene infiltration. (d-f) Cross section of a MX-PS sample with five times MXene infiltration. (a, d) Optical images of the cross section. (b, e) High magnification raw SEM images at the center of cuboids, showing the morphology. (c, f) Corresponding EDX maps for Si (representing silica) and Ti (representing MXene) at the regions shown in band e. Arrows in (a) and (d) show the main pore orientation of silica backbones due to unidirectional freeze casting. All scale bars represent 30 μm. FIG. 13: Comparison of the decay in electrical conductivity of MX-PS with MXene aerogels (synthesis described in the Methods section) molded in the shape of 1 mm×1 mm×10 mm. These dimensions are similar to those of the cuboid MX-PS samples. Note that the conductivity was measured along the long dimension.

FIG. 14A-B: Engineering stress-strain plots for (a) the freeze-cast porous silica backbone with 60% nominal porosity, and (b) freeze-dried MXene aerogel; both compressed along the dominant pore direction. Note that the engineering stress may be calculated by considering the apparent area of the porous silica backbone and the porous MXene aerogel.

FIG. 15A-C: The comparison of the MX-PS supercapacitor with non-MXene supercapacitor.
(a) CV curves at 10 mV/s scan rate. (b) GCD curves at a current density of 2 mA cm-². Inset shows the GCD curve of the non-MXene supercapacitor. In both figures, a dashed blue line is used for the non-MXene supercapacitor results, and a continuous green line is used for the MX-PS supercapacitor results. (c) Comparison plot for the impedance amplitude of MX-PS and non-MXene supercapacitor.

FIG. 16: Mass increase (%) in porous silica after MXene infiltration and surface cleaning as a function of MXene concentration.

FIG. 17A-B: Performance of MX-PS supercapacitor comprise of silica electrodes with 60% longitudinal porosity infiltrated with 90 mg/ml MX slurry. (a) CV curves at various scan rates. (b) GCD curves at various charge/discharge rates.

FIG. 18A-B: Performance of the MX-PS supercapacitor comprise of silica electrodes with 40% longitudinal porosity infiltrated with 180 mg/mL MX slurry. (a) CV curves at various scan rates.
(b) GCD curves at various charge/discharge rates.

FIG. 19: EIS comparison of MX-PS supercapacitors of electrodes with longitudinal (green) and lateral (red) porosity. The electrodes consisted of 60% porous silica infiltrated with 180 mg/mL MX slurry. Inset shows the high-frequency region.

FIG. 20A-B: Performance of the MX-PS supercapacitor comprise of silica electrodes with 60% lateral porosity infiltrated with 180 mg/mL MX slurry. (a) CV curves at various scan rates. (b) GCD curves at various charge/discharge rates.

FIG. 21: Capacitance retention of MX-PS supercapacitors (180 mg/mL) after 10,000 charge-discharge cycles at 32 mA cm-² current density. Figure Sl4 shows the cyclic stability of supercapacitors with MX-PS electrodes (with MX180) at a current density of 32 mA/cm2. It is observed a 24.7% decrease in capacitance at the end of 10,000 cycles. This performance is within the range or better than those reported in the literature for MXene-based supercapacitors. There are multiple possible causes of this modest degradation in performance: The oxidation of MXene is likely to cause a performance drop since the assembly and testing of MX-PS supercapacitors are done at room conditions (not in a glove box). The effect of MXene oxidation on the capacitance of assembled supercapacitors requires further investigation. Additionally, repeated charge and discharge cycles during the cycling process can lead to structural changes, resulting in a loss of capacitance. This can occur due to material fatigue, the formation of a passivating layer on the electrode surface, or the dissolution of active material (MXene) into the electrolyte. Cycling-induced mechanical strain can cause active materials to detach or degrade, leading to a loss of active surface area and decreased capacitance. The acidic electrolyte (due to H2SO4) might react with the Cu tape and potentially with the Ag paint. Sulfuric acid can react with copper through an oxidation-reduction reaction, where the acid acts as an oxidizing agent. Copper can be oxidized, resulting in the formation of copper sulfate (CuSO4) or copper sulfide (CuS). The reaction rate is influenced by factors such as acid concentration, temperature, exposure time, and the presence of other substances. In dilute concentrations, sulfuric acid may have little to no effect on silver. It is worth noting that the presence of impurities or other substances in the sulfuric acid solution can also impact the reactivity with silver. For example, the presence of chloride ions can increase the likelihood of silver corrosion.

FIG. 22A-B: A stacked pouch-cell assembly is shown in FIGS. 5e and 5f. (a) The Nyquist plot from EIS depicting the low resistance of the pouch cell; (b) The Bode magnitude plot showing the low impedance of the pouch cell, similar to that of the single cell, over the entire frequency domain tested in EIS.

FIG. 23A-D: Preparation of sandwich-type supercapacitors using MXene infiltrated porous silica (MX-PS) samples as electrodes. (a) Electrical connection to MX-PS using silver paste, copper tape, transparent nail polish, and Kapton™ tape. (b) Saturation of electrode with the electrolyte. (c) Sandwich-type assembly. (d) Packaging using Kapton™ tape.

FIG. 24: The experimental images of the infiltration of porous elongated cuboid silica samples with MXene dispersion.

FIG. 25A-B: Optical images showing the effect of MXene cleaning on the external surfaces of (a) elongated cuboid and (b) cube shaped samples.

FIG. 26A-B: (a) Preparation of high-concentration MXene dispersion by minimally intensive layer delamination method. (b) Calculation of MXene concentration using TGA.

FIG. 27: Raw TEM image of a 2D ThC2Tx MXene nanosheet. Arrows indicate the boundary of the MXene nanoflake. The inset shows the SAED pattern with the typical hexagonal symmetry of ThC2Tx MXene.

FIG. 6: Mercury porosimetry results of freeze-cast porous silica samples (60% nominal porosity). The test was performed at an absolute pressure range of 0-414 MPa.

FIG. 7: Effect of the MXene concentration in the dispersant and the number of infiltration cycles on the mass of elongated MX-PS cuboid samples (1 mm×1 mm×10 mm) with 60% porosity at different steps of the infiltration and surface cleaning processes.

The porous silica backbone may be a 1 mm×1 mm×10 mm elongated cuboid. During MXene infiltration, due to capillarity, MXene dispersion quickly wets the porous sample once the sample touches the liquid. The cylindrical well may be filled with a smaller amount of MXene dispersion, compared to the normal infiltration process, to monitor the porous silica sample and the wetting by the MXene dispersion during the process. For normal infiltration procedure, full submersion of the sample may be achieved by putting 300-400 μL MXene dispersion in the container.

### DETAILED DESCRIPTION

This disclosure generally describes nanomaterials (such as atomically thin 2D nanomaterials or 1D nanomaterials or OD nanoparticles) and methods of arranging the same in three-dimensional space and their applications. It is understood, however, that this disclosure also embraces numerous alternative features, aspects, and advantages that may be accomplished by combining any of the various features, aspects, and/or advantages described herein in any combination or sub-combination that one of ordinary skill in the art may find useful. Such combinations or sub-combinations are intended to be included within the scope of this disclosure. As such, the claims may be amended to recite any features, aspects, and advantages expressly or inherently described in, or otherwise expressly or inherently supported by, this disclosure. Further, any features, aspects, and advantages that may be present in the prior art may be affirmatively disclaimed. Accordingly, this disclosure may comprise, consist of, consist essentially or be characterized by one or more of the features, aspects, and advantages described herein. As used herein, the term “and/or” includes any and all combinations of one or more of the associated listed items.

All numerical quantities stated herein are approximate, unless stated otherwise. Accordingly, the term “about” may be inferred when not expressly stated. The numerical quantities disclosed herein are to be understood as not being strictly limited to the exact numerical values recited. Instead, unless stated otherwise, each numerical value stated herein is intended to mean both the recited value and a functionally equivalent range surrounding that value. At the very least, and not as an attempt to limit the application of the doctrine of equivalents to the scope of the claims, each numerical value should at least be construed in light of the number of reported significant digits and by applying ordinary rounding processes. Typical exemplary degrees of error may be within 20%, 10%, or 5% of a given value or range of values. Alternatively, and particularly in biological systems, the terms “about” refers to values within an order of magnitude, potentially within 5-fold or 2-fold of a given value.

Notwithstanding the approximations of numerical quantities stated herein, the numerical quantities described in specific examples of actual measured values are reported as precisely as possible. Any numerical values, however, inherently contain certain errors necessarily resulting from the standard deviation found in their respective testing measurements.

All numerical ranges stated herein include all sub-ranges subsumed therein. For example, a range of “1 to 10” or “1-10” is intended to include all sub-ranges between and including the recited minimum value of 1 and the recited maximum value of 10 because the disclosed numerical ranges are continuous and include every value between the minimum and maximum values. Any maximum numerical limitation recited herein is intended to include all lower numerical limitations. Any minimum numerical limitation recited herein is intended to include all higher numerical limitations. All compositional ranges stated herein are limited in total to and do not exceed 100 percent (e.g., volume percent or weight percent) in practice. When multiple components may be present in a 2D nanomaterials that can bring exciting advances to a range of applications, such as energy storage, catalysis, water purification, and sensing. Their advantages may include ultrahigh surface-to-volume ratio, tunable surface chemistry, outstanding mechanical strength, and unique optical, electrical, and catalytic properties. Specifically, MXenes may show superior electrochemical stability and high specific capacitance-exceeding many carbonaceous materials-making them promising candidates as supercapacitors. ThC2Tx is a type of MXene produced by selective etching of Al atoms from the ThAlC2 MAX phase. ThC2Tx has attracted much attention, primarily due to its well-established preparation process and its dispersibility in aqueous media without surfactants, owing to the presence of surface functional groups. Several studies with ThC2Tx have demonstrated its significant potential for various applications, including energy storage, solar energy conversion, and electromagnetic interference shielding.

The use of MXene (or other 2D materials) in many device applications may require that a sufficient amount of material is available for electrochemical activities (e.g., intercalation in lithium-ion batteries). However, obtaining a large volume of 2D materials in 3D space may pose a significant barrier. This may be because MXenes and other 2D materials have a strong tendency to restack during assembly due to strong van der Waals forces. Restacking may compromise the accessibility of individual flakes, greatly impeding their performance in surface-sensitive applications, such as electrochemical energy storage. For instance, restacking when arranging the 2D nanomaterials may impede electrolyte penetration and ion diffusion in energy storage applications. The MXene layers located toward the center of the stack may have a significantly reduced impact on the overall performance. This has been a critical problem in realizing practical applications of MXene, such as MXene-based electrochemical supercapacitors that require interconnected 3D arrangements of 2D MXene nanoflakes to achieve the desired performance.

Techniques for assembling MXene and other 2D nanomaterials into 3D architectures may be categorized as direct fabrication methods and methods that use a (generally sacrificial) support structure. Several direct fabrication approaches may involve freeze-drying and 3D printing for the 3D arrangement of MXenes. MXene may be combined with carbon network for Li—S battery applications. However, the strength improvement achieved via this approach may be difficult to quantify. Another approach may be integrating MXene flakes into nanoyams via bath electrospinning. Yet another approach may be using gelation to obtain freestanding 3D MXene aerogels by introducing chemical additives, such as Na+ ions, sodium alginate, and ethylenediamine. Other approaches may include using 3D printing to create MXene structures; fabricating 3D MXene structures using extrusion-based printing of concentrated inks; and using sacrificial 3D-printed hollow (resin) templates with complex geometries, which may be subsequently filled with MXene inks to achieve enhanced design customization. However, these fragile MXene aerogels may require additional mechanical support without blocking the accessibility of the porous structure. Another composition, the sum of the maximum amounts of each component may exceed 100 percent, with the understanding that, and as those skilled in the art would readily understand, that the amounts of the components may be selected to achieve the maximum of 100 percent.

In the following description, certain details are set forth in order to provide a better understanding of various features, aspects, and advantages the invention. However, one skilled in the art will understand that these features, aspects, and advantages may be practiced without these details. In other instances, well-known structures, methods, and/or processes associated with methods of practicing the various features, aspects, and advantages may not be shown or described in detail to avoid unnecessarily obscuring descriptions of other details of the invention.

The terminology used herein is for the purpose of describing particular examples only and is not intended to be limiting. As used herein, the singular forms “a”, “an”, and “the” may be intended to include the plural forms as well, unless the context clearly indicates otherwise. The terms “comprises”, “comprising”, “including”, “having”, and “characterized by”, are inclusive and therefore specify the presence of stated features, elements, compositions, steps, integers, operations, and/or components, but do not preclude the presence or addition of one or more other features, integers, steps, operations, elements, components, and/or groups thereof. Although these open-ended terms are to be understood as a non-restrictive term used to describe and claim various aspects set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, described herein also specifically includes embodiments consisting of, or consisting essentially of, such recited compositions, materials, components, elements, features, integers, operations, and/or process steps. In the case of “consisting of”, the alternative embodiment excludes any additional compositions, materials, components, elements, features, integers, operations, and/or process steps, while in the case of “consisting essentially of”, any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on”, “engaged to”, “connected to”, or “coupled to” another element or layer, it may be directly on, engaged, connected or coupled to the other component, element, or layer, or intervening elements or layers may be present. In contrast, when an element is referred to as being “directly on”, “directly engaged to”, “directly connected to”, or “directly coupled to” another element or layer, there may be no intervening elements or layers present. Other words used to describe the relationship between elements should be interpreted in a like fashion (e.g., “between”versus “directly between”, “adjacent” versus “directly adjacent”, etc.). Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first”, “second”, and other numerical terms when used herein may not imply a sequence or order unless clearly indicated by the context. Thus, a first step, element, component, region, layer or section discussed below may be termed a second step, element, component, region, layer or section without departing from the teachings herein.

Spatially or temporally relative terms, such as “before”, “after”, “inner”, “outer”, “beneath”, “below”, “lower”, “above”, “upper”, and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures. As used herein, “top” means furthest away from the substrate, while “bottom” means closest to the substrate. Where a first layer is described as “disposed over”, “provided over”, or “deposited over” a second layer, the first layer is disposed further away from substrate. There may be other layers between the first and second layer, unless it is specified that the first layer is “in contact with”, “disposed on”, “provided on”, or “deposited on” the second layer.

The terms “on”, “appended to”, “affixed to”, “bonded to”, “adhered to”, or terms of like import means that the designated item, e.g., a coating, film or layer, is either directly connected to (superimposed on) the object surface, or indirectly connected to the object surface, e.g., through one or more other coatings, films or layers (superposed on).

Nanomaterials may exhibit exceptional properties due to their high surface-to-volume ratio. These properties, however, may not be effectively utilized unless they are arranged in 3D space such that their surfaces are available for reaction in a device. This invention describes a scalable method of arranging nanomaterials in 3D space as well as devices comprising the same. For example, nanomaterials may be coated on inner surfaces of porous structures via capillary action, forming the 3D structure.

An example of nanomaterials is 2D MXene, while an example of porous structure is freeze-cast silica ceramic. MXenes are a class of two-dimensional inorganic compounds that include atomically thin layers of transition metal carbides, nitrides and carbonitrides are an emerging class of approach may combine inkjet-based 3D printing with ice templates to fabricate 3D MXene aerogels with complex geometries. As an alternative to aerogel-based 3D construction of MXene, 2D MXene nanosheets separated by 1D nanomaterials, e.g., MnO2 nanowires, or polymers, e.g., PANI, may be assembled to create 3D MXene structures, where the separating elements are used to eliminate the restacking.

Three techniques that use support structures for assembling 2D nanomaterials into 3D architectures include: direct drop casting, electrophoretic deposition, and chemical vapor deposition. Direct drop casting may be used to create electrically conductive MXene-infiltrated textiles and graphene-coated elastomeric foams. However, nanomaterial agglomeration, limited infiltration depth, and the inherent challenge of achieving high loading amounts may hinder the feasibility of this approach for many applications. Electrophoretic deposition may be used to fabricate MXene-coated carbon cloth as a flexible electrode material. Although electrophoretic deposition may provide high precision, it may require electrically conductive porous scaffolds, limiting the types of materials used for the 3D support structure. Chemical vapor deposition may be used for the templated growth of graphene, graphite, and other 2D materials on scaffolds through the thermal decomposition of the precursor gases. However, the limited precursor availability may restrict the range of materials deposited onto the porous scaffolds. Hence, these methods may not provide a desirable combination of versatility, reproducibility, and scalability of integrating various nanomaterials into 3D support structures for practical applications.

MXene-based electrodes may be used in supercapacitor applications. Freeze-dried MXene aerogel-based electrodes may produce areal capacitances of 1.01 and 4.03 F cm-² with 15 and 14.2 mg cm-² active mass (MXene) loadings, respectively, at 2 mV s-¹ scan rate. The extrusion-based 3D printed MXene electrodes may produce an areal capacitance of 1.04 F cm-² (at 2 mV s-¹) with 9.92 mg cm-² mass loading. The MXene aerogel electrodes may exhibit an areal capacitance as high as 7.5 F cm-² (at 0.5 mA cm-²) with a mass loading of 54.1 mg cm-². The electrodes formed by 2D MXene nanosheets separated by MnO2 nanowires and PANI may produce areal capacitances of 0.2 F cm-² (at 0.2 mV s-¹) and 7.96 F cm-² (at 2 mV s-¹) for MXene loadings of 1 and 23.61 mg cm-², respectively. The flexible electrodes of MXene-integrated carbon cloth may have an areal capacitance of 5.73 F cm-² (at 5 mA cm-²) using 34.9 mg cm-² mass loadings. Higher areal capacitances achieved via the

use of higher amounts of active mass (MXene) loading may indicate that the capacitance achieved per unit MXene mass may be a more appropriate metric to describe the performance of MXene-based electrodes. By improving the 3D construction of 2D MXene, the performance of MXene-based electrodes and supercapacitors may be significantly increased using less active mass loading.

This disclosure is directed to an entirely new material system comprising a 3D network of nanomaterials. An example is 2D MXene inside a porous ceramic backbone. The architecture of the 3D MXene network may be controlled by adjusting the backbone's porosity distribution and the MXene infiltration into it. To achieve this, ceramic freeze casting may be utilized to create porous silica structures that have open hierarchical porosity and a controlled porosity distribution. MXene may be then infiltrated into the porous silica using capillary flow, and the system may be dried out to create the MXene-infiltrated porous silica (MXPS) system. The drying process may enable the 2D MXene flakes to conformally coat the inner surfaces of the interconnected micropore network within the silica. The porous silica backbone may facilitate the 3D assembly of MXene and may offer certain attributes desirable for electrochemical applications, such as mechanical strength, electrical insulation, and permeability. Importantly, the fabrication approach may be reproducible and scalable. The reproducible fabrication of the MX-PS system and analyze the effects of porosity, MXene concentration, and infiltration cycles on conductivity is described herein. The directionality of electrical conductivity of the MX-PS samples arising from the selective orientation of the pores is also described. The effectiveness of MX-PS as electrodes on a sandwich-type supercapacitor is described, and their energy density and power capacity are compared to certain MXene devices. The methods according to the present disclosure may generate a controllable 3D MXene network architecture combined with a porous ceramic backbone.

The fabrication of MX-PS is summarized in FIG. 1. Porous silica backbones may be formed using unidirectional freeze casting of a camphene-based slurry. This freeze-casting approach may produce porous silica backbones having open pores and directional porosity, including a major pore direction with increased pore connectivity and elongated pores, see FIG. 1a; and FIG. 8A-D. In this process, a ceramic or metal slurry may be “frozen” anisotropically to create green porous structures having controlled porosity that may be then sintered to achieve part strength. Freeze casting may be a simple, scalable, and material-agnostic technique to develop open, controlled, hierarchical, and directional porosity. Well-defined, interconnected, and steerable internal porosity may be achieved in silica via freeze casting. FIG. 6 may provide the specific pore volume, specific surface area, permeability, and pore tortuosity of the freeze-cast silica in this work, all of which were measured by mercury porosimetry. In parallel, ThC2Tx MXene of known hydrodynamic diameter may be synthesized using the following procedure: To prepare the MXene dispersion, ThC2Tx MXene flakes were synthesized using the minimally intensive layer delamination (MILD) method. Briefly, Ti3 AlC2 MAX powder (<40 μm particle size, Carbon-Ukraine Ltd., Kyiv, Ukraine) was etched with a mixture of hydrochloric acid and lithium fluoride under continuous stirring at room temperature for 24 hours. Subsequently, the synthesized acidic Ti3C2Tx MXene was washed several times with deionized (DI) water to increase its pH up to 6. At each wash cycle, MXene was dispersed into the newly added DI water by shaking the container manually, and the obtained slurry was centrifuged to precipitate Ti3C2Tx flakes while discarding the liquid part. At the last wash cycle, about 5 mL DI water was added to the precipitated Ti3C2Tx to create a high-concentration mixture. The overall preparation procedure is shown in FIG. 26a. The MXene concentration of the prepared dispersion was calculated using thermogravimetric analysis (TGA). The MXene may be dispersed in deionized (DI) water at specific ratios to obtain MXene dispersions at desired concentrations, as shown in FIG. 1c-e. The porous silica backbones may be subsequently submerged in a dispersion of MXene to facilitate the infiltration of MXene into the pores of the backbone. Following the infiltration process, the samples may be dried in a vacuum environment. This approach may effectively facilitate

capillary-driven conformal coating of the MXene onto the pore surfaces. FIG. 1b shows a sample backbone with MXene coating the pore surfaces. The open porosity of the backbones may enable the creation of MX-PS composite materials with the connected 3D assembly of MXene nanoflakes.

The morphology of the pores created on the porous silica backbone may be important to the architecture of the 3D MXene network. The preparation steps may include 20% solid loading, 400 nm particle size, and −5 °C freezing (bottom surface) temperature to fabricate porous-silica backbones.

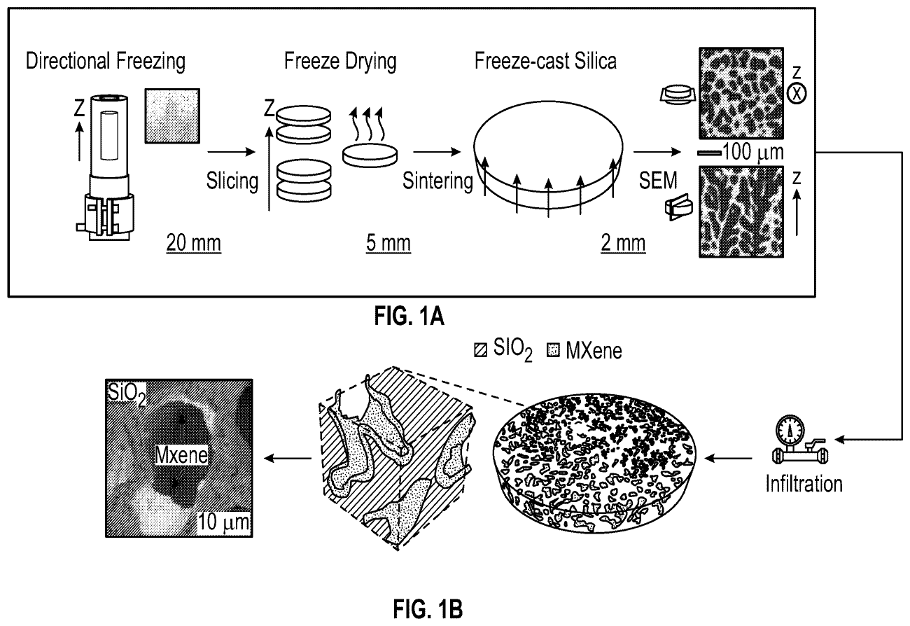

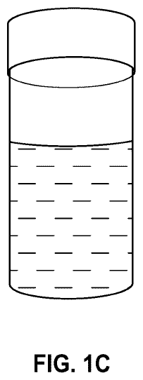

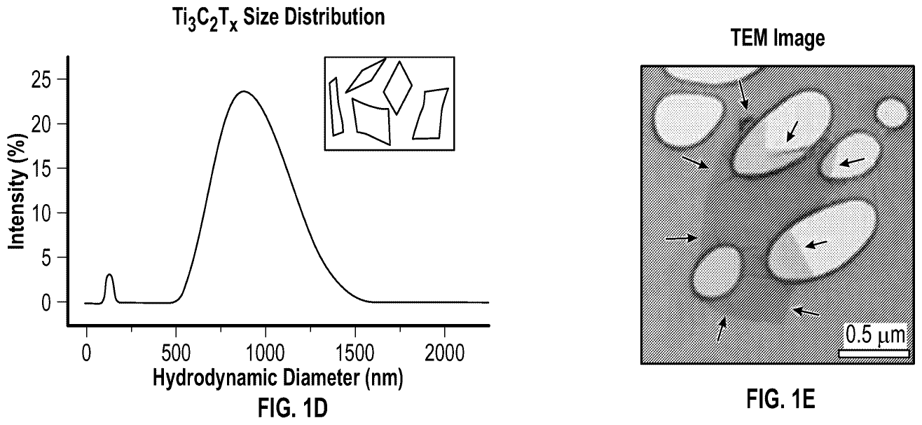

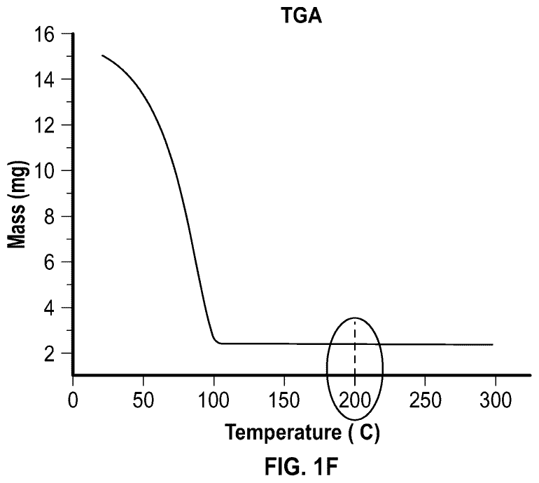

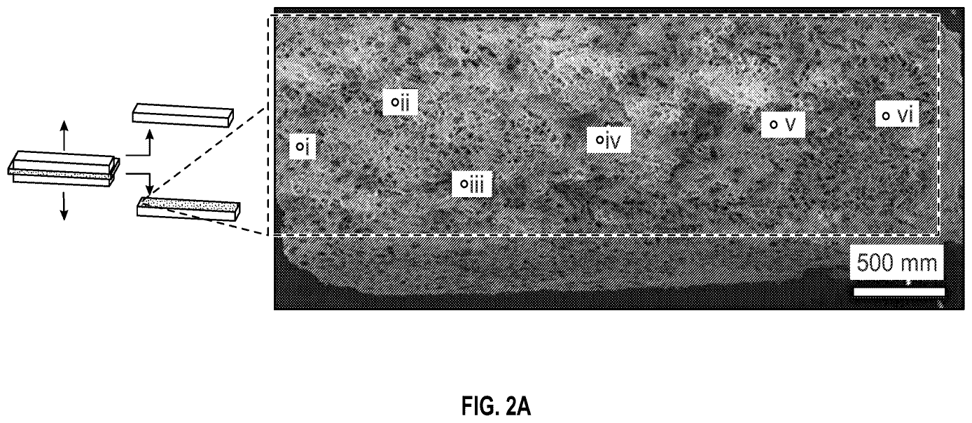

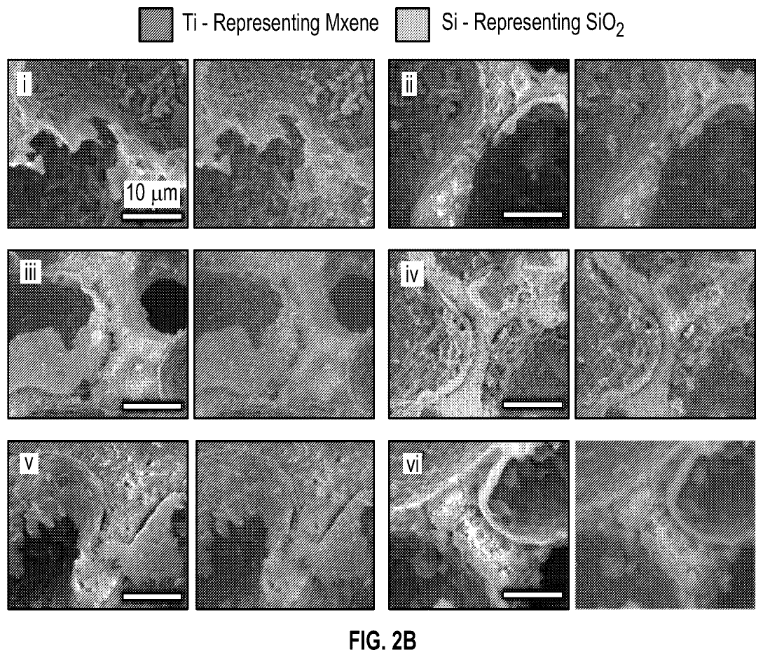

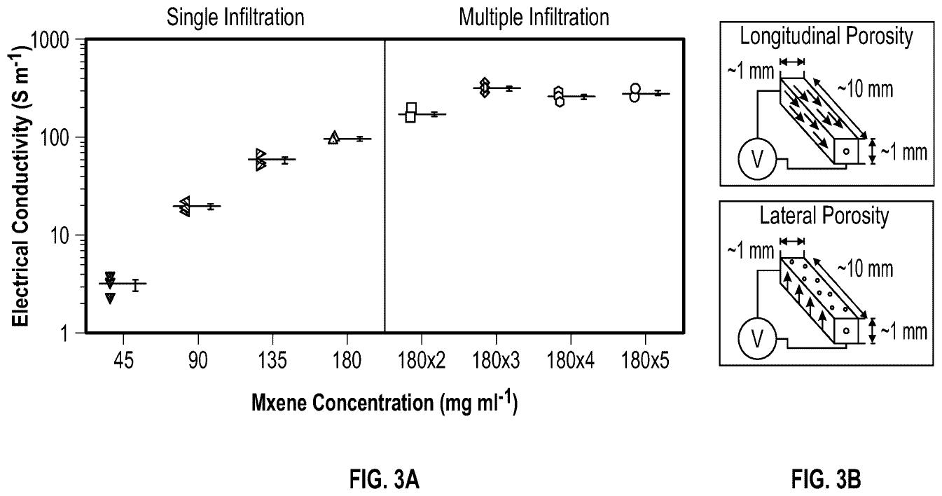

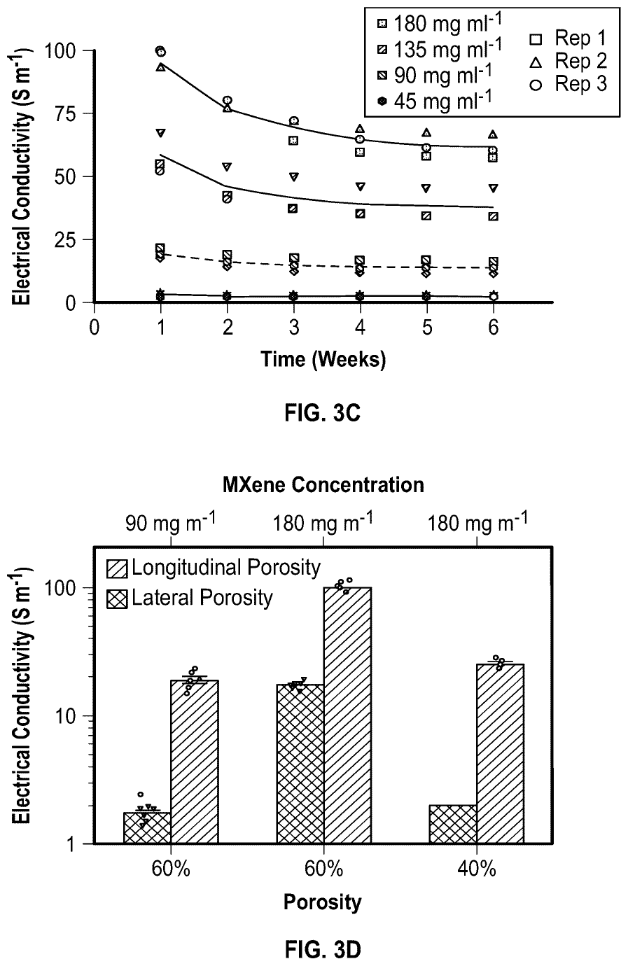

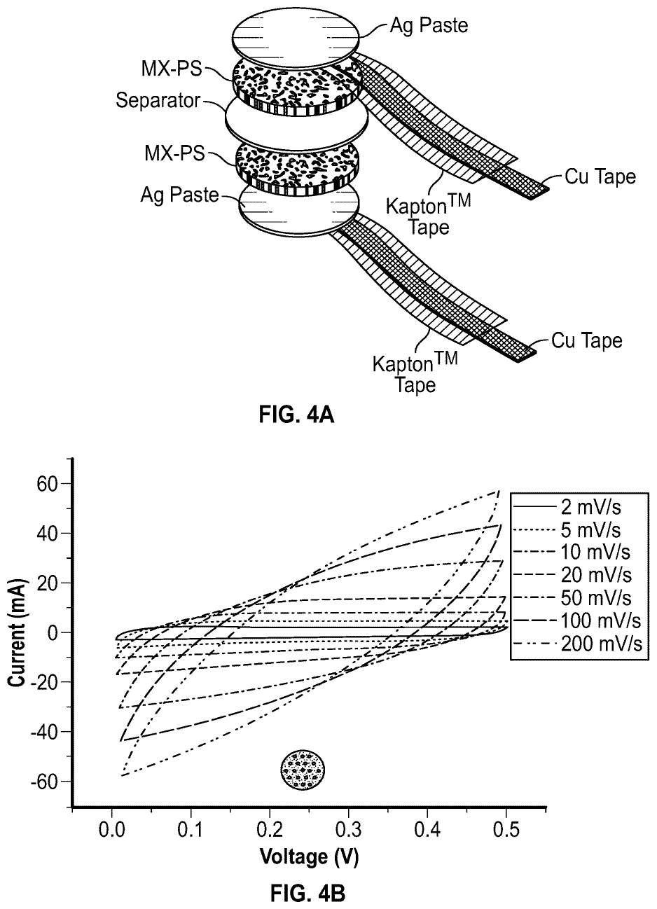

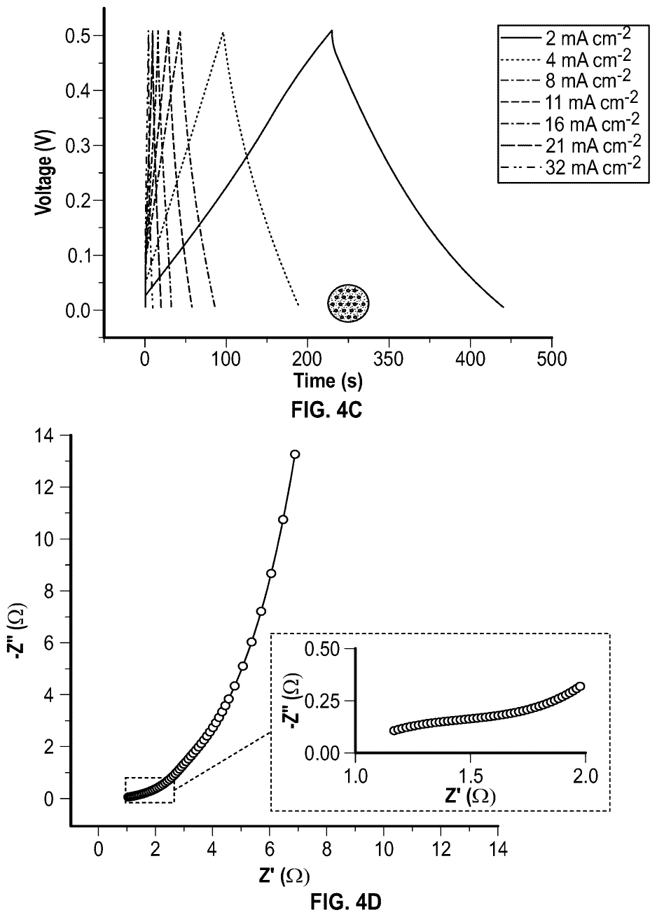

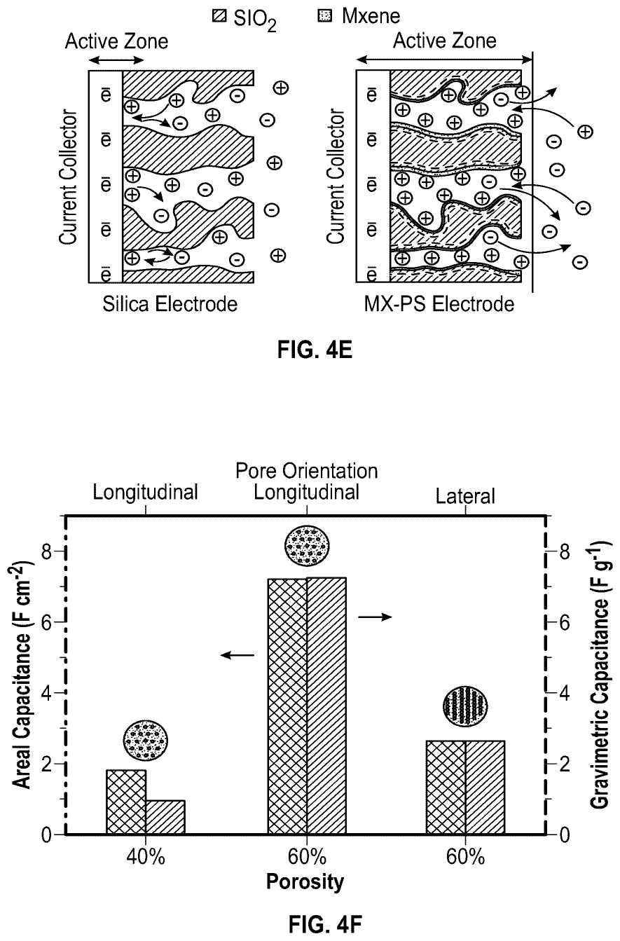

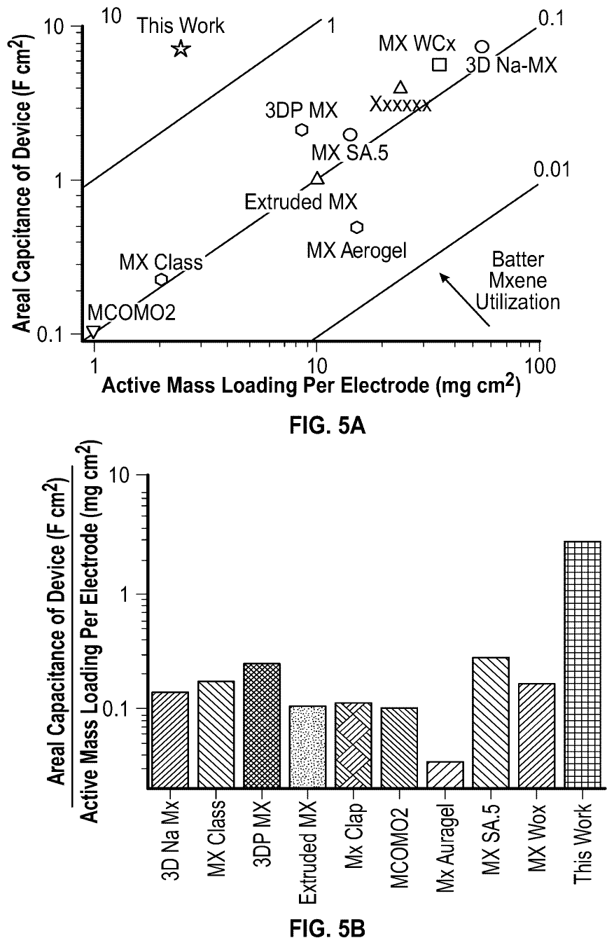

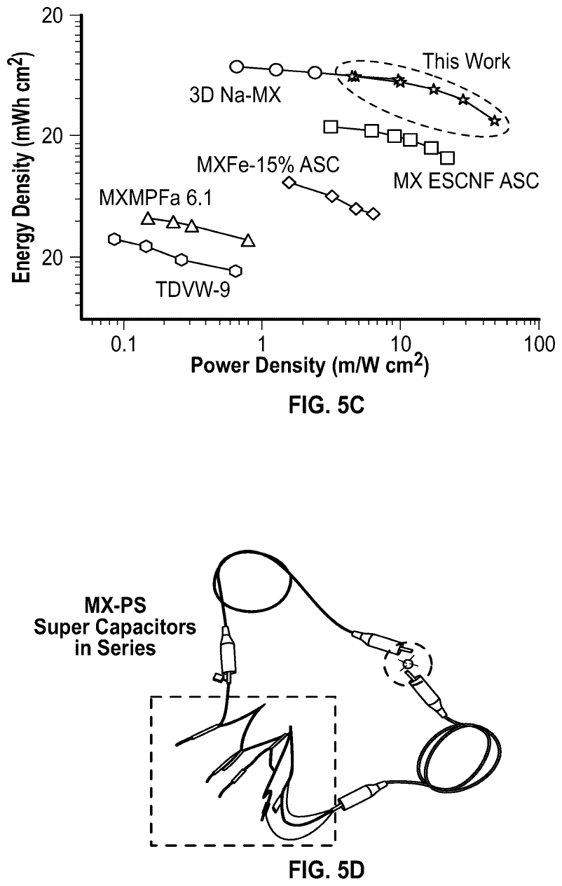

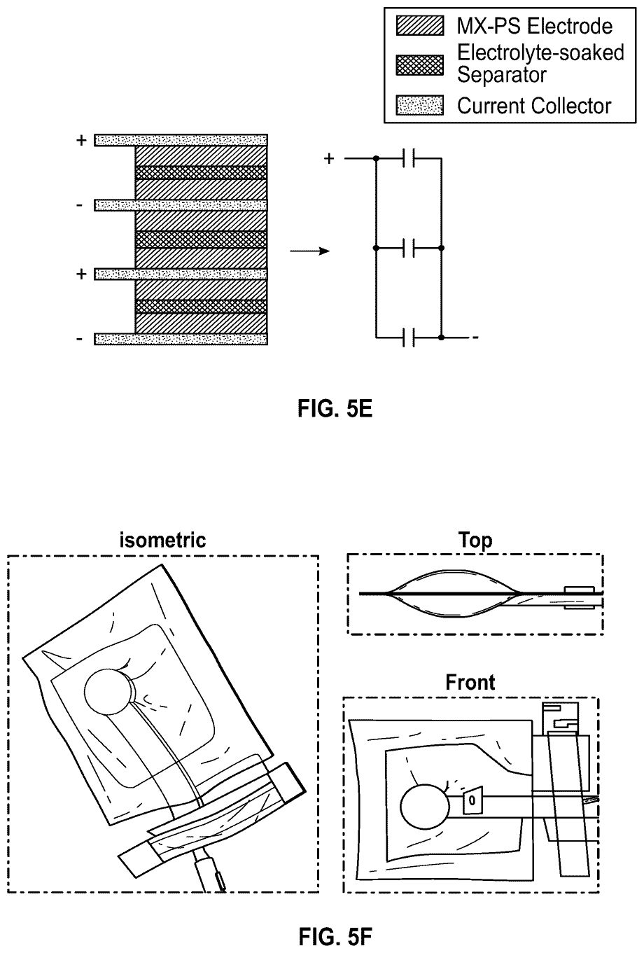

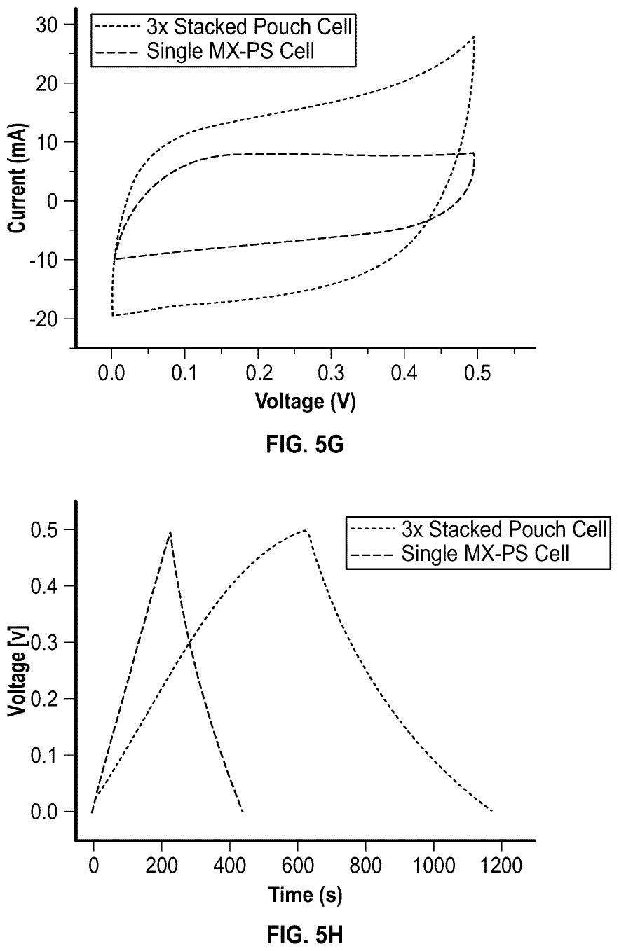

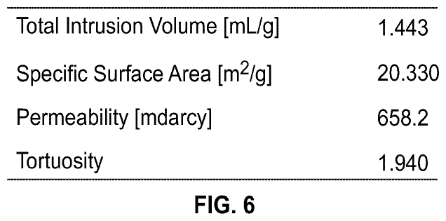

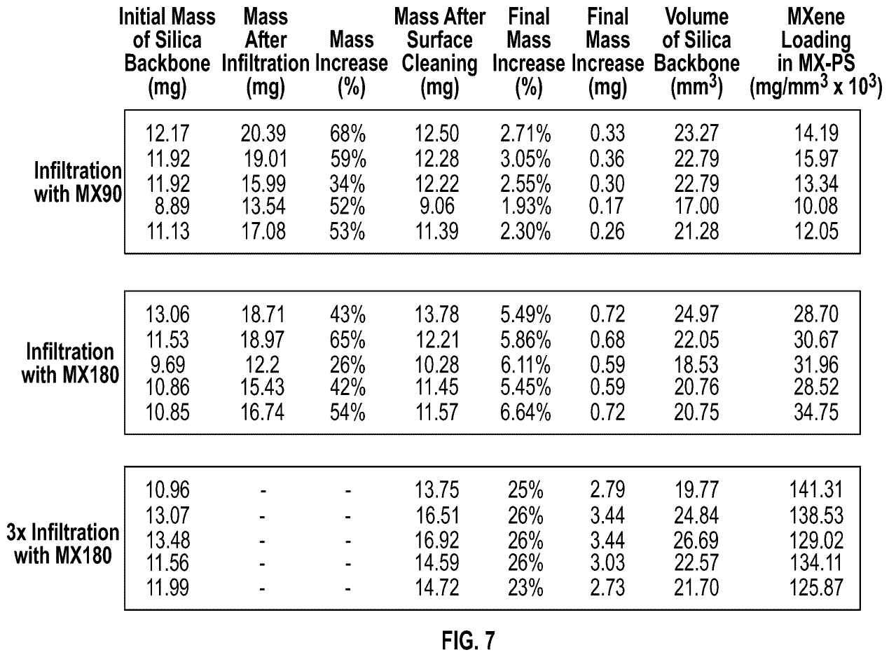

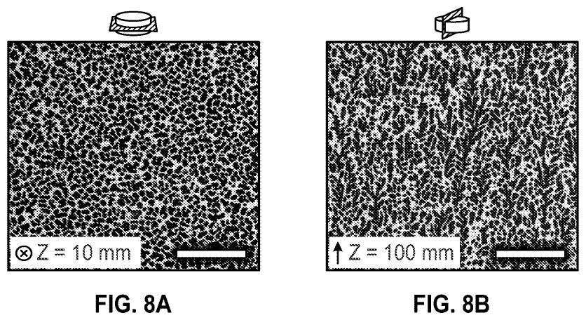

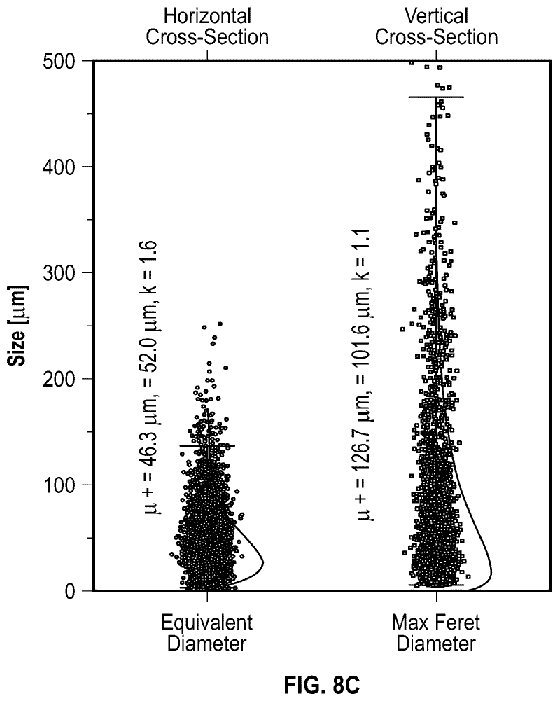

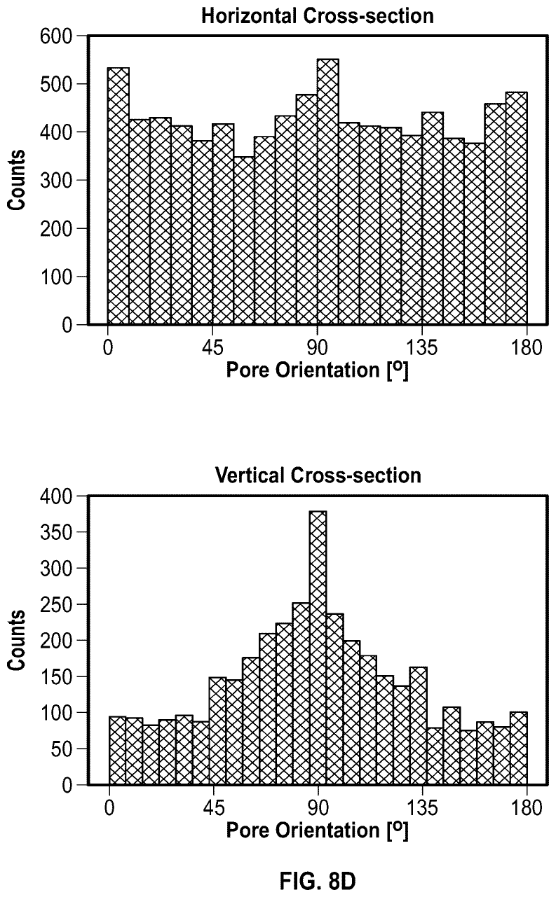

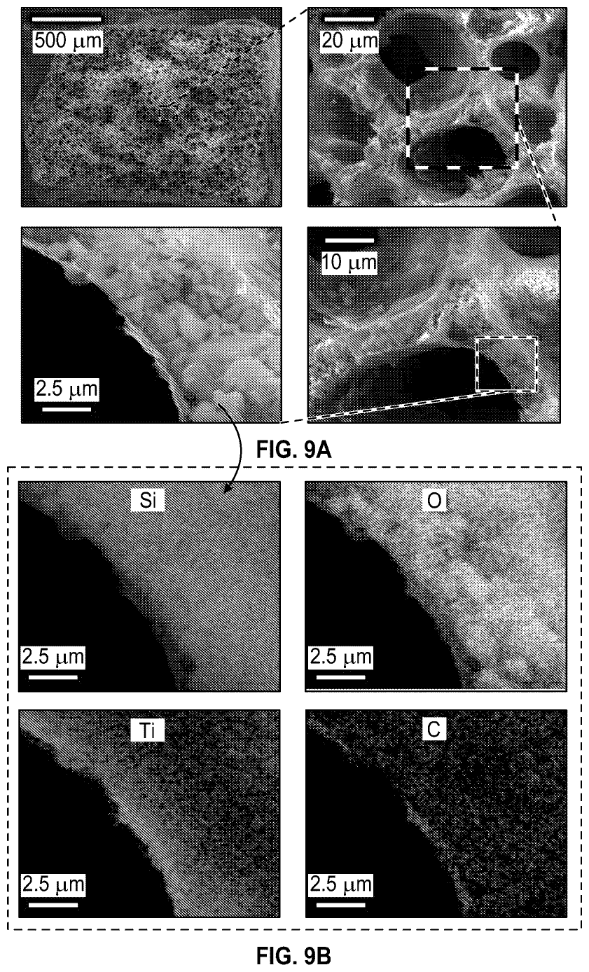

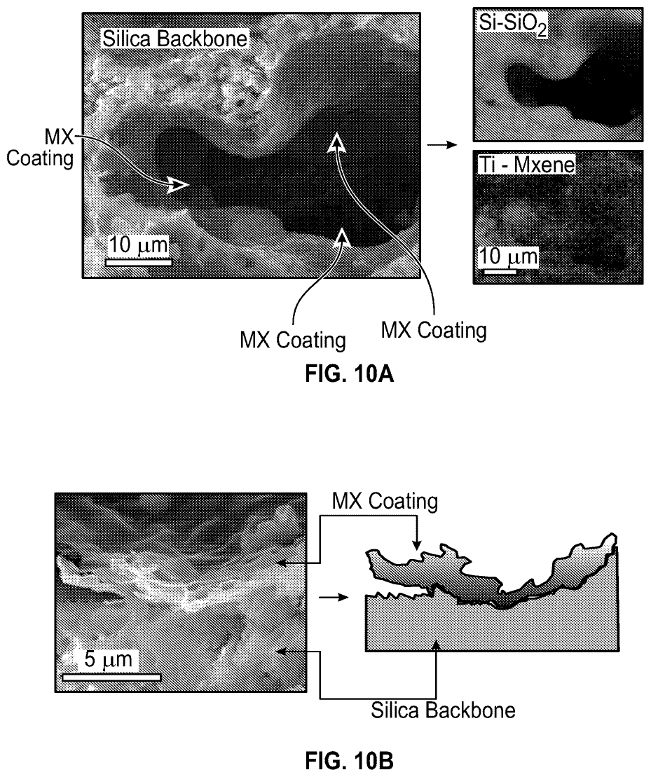

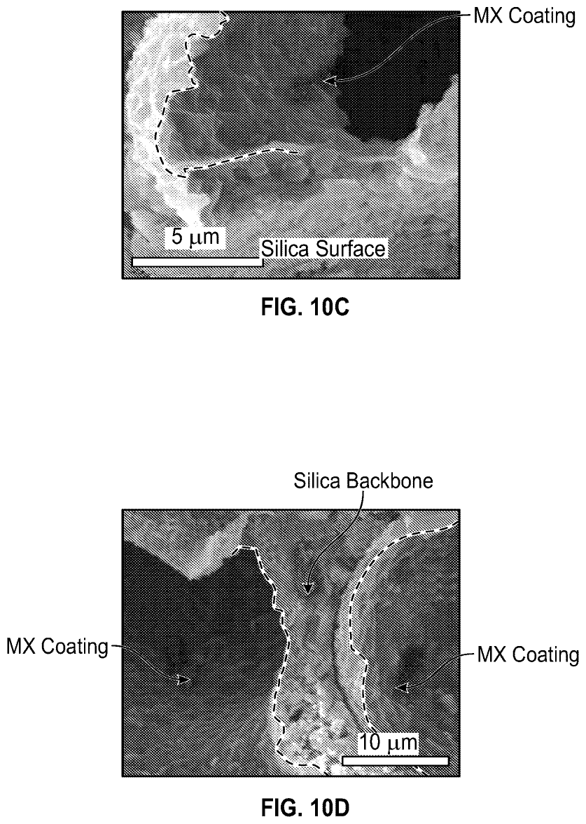

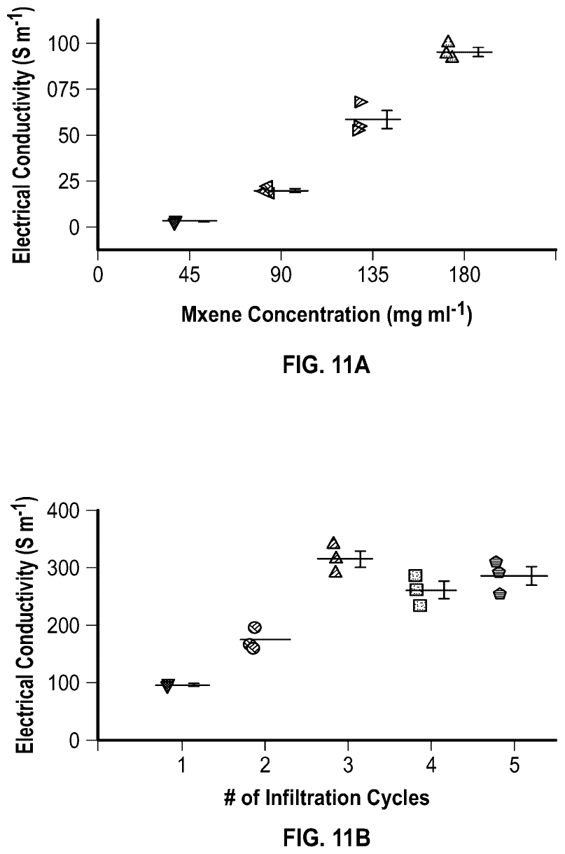

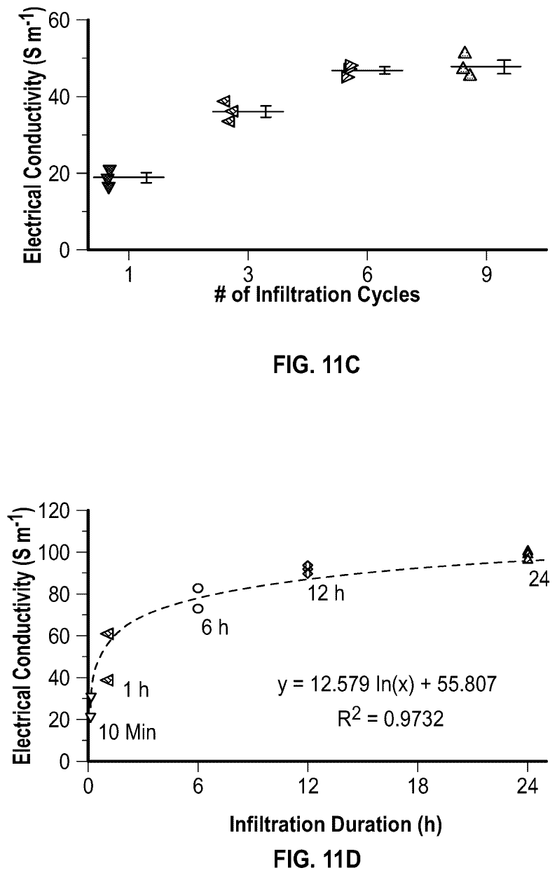

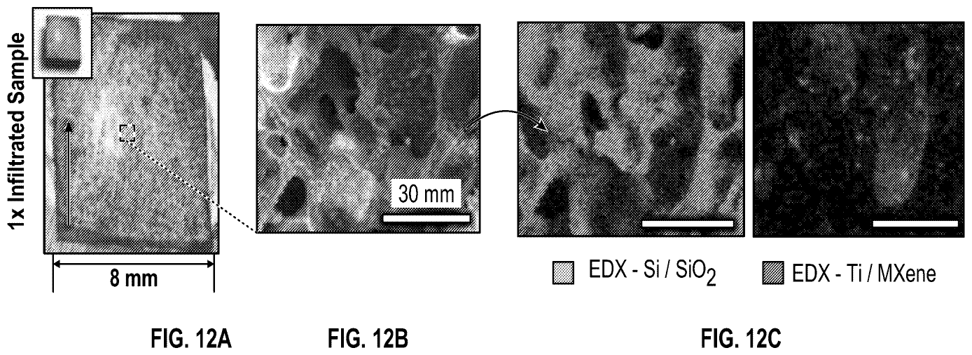

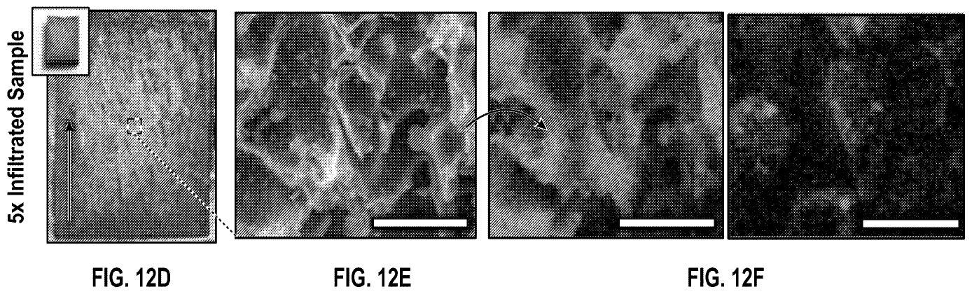

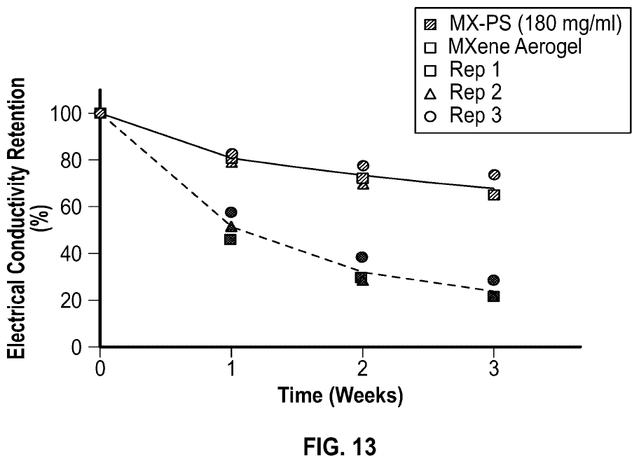

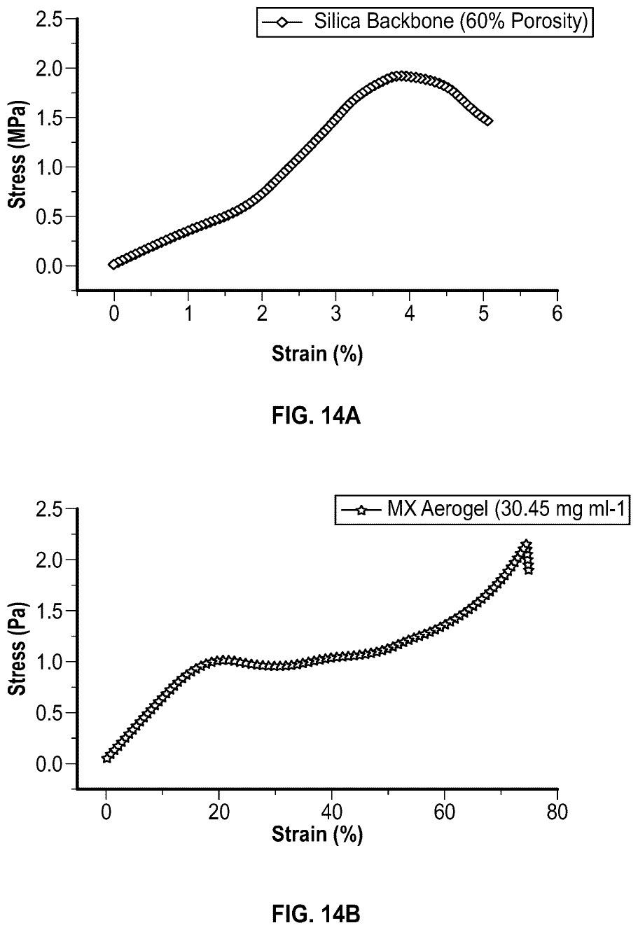

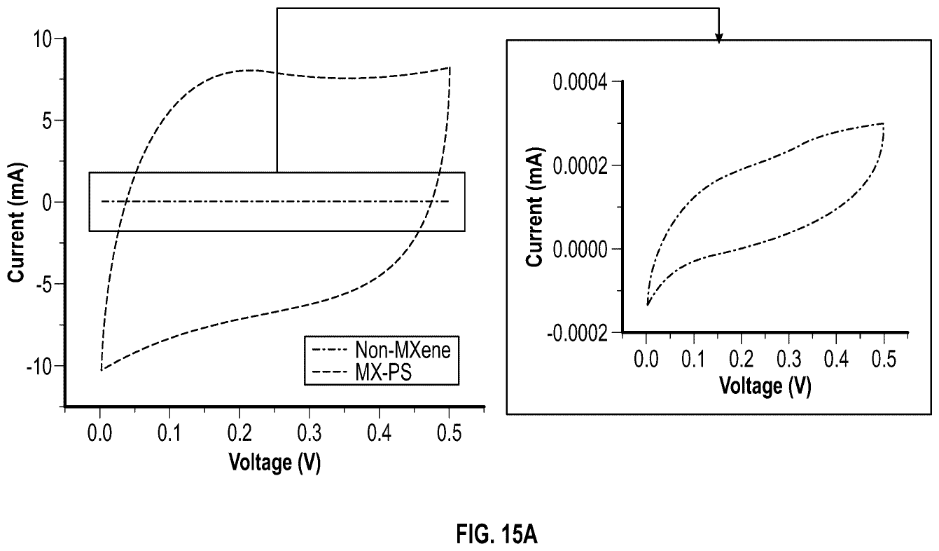

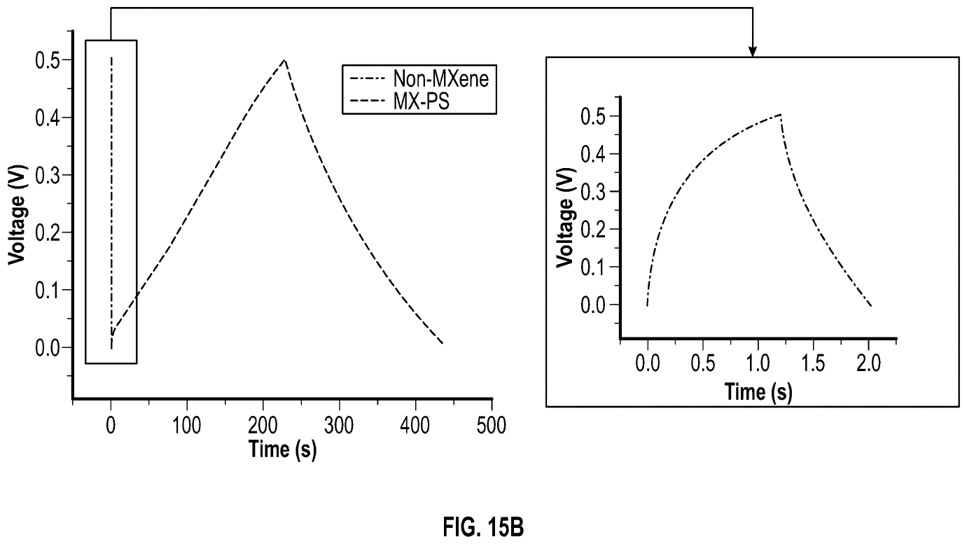

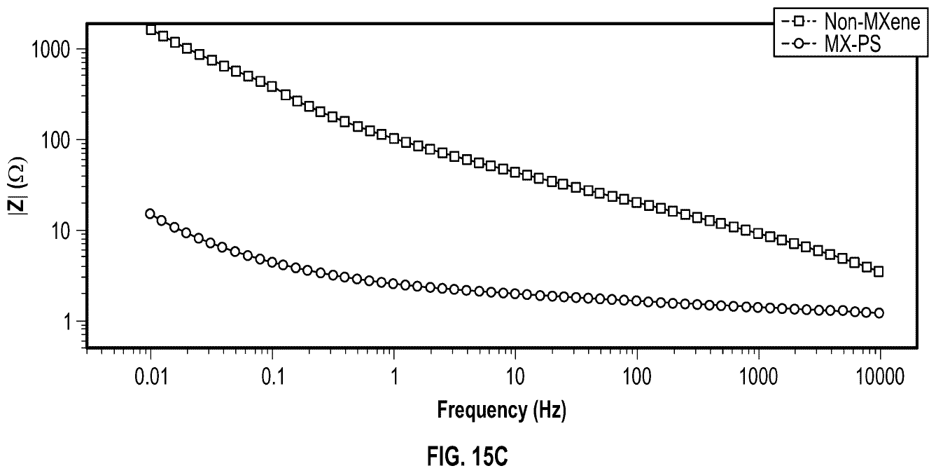

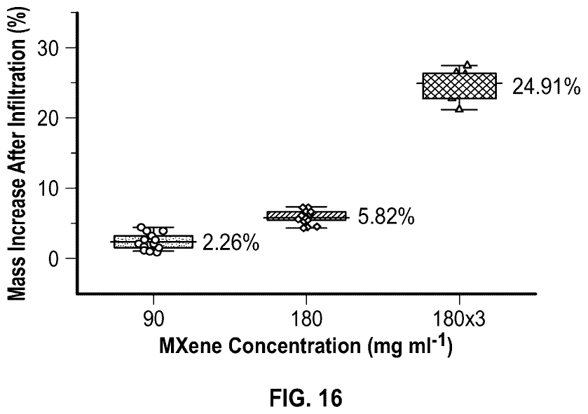

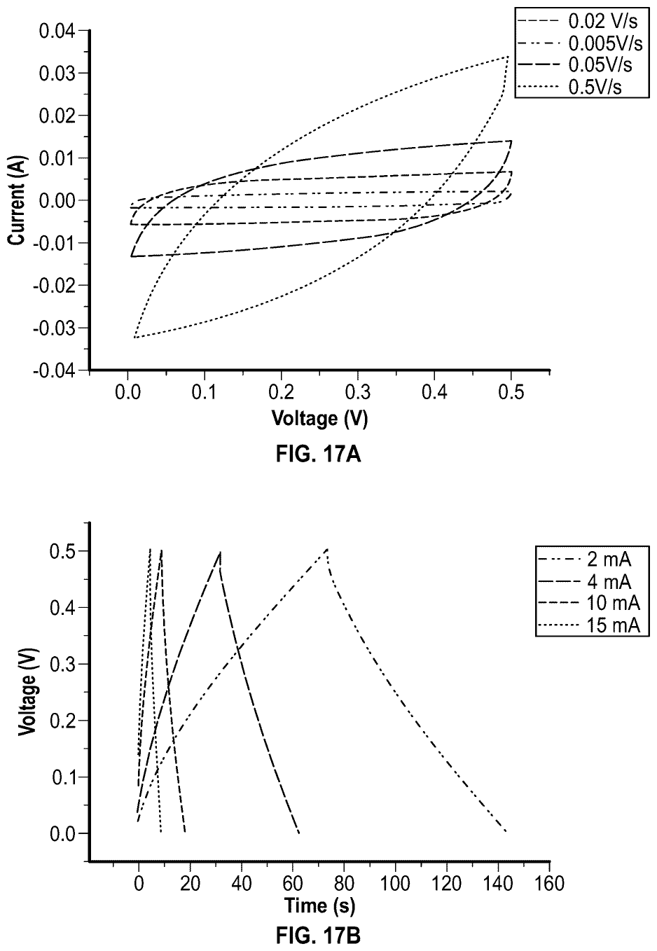

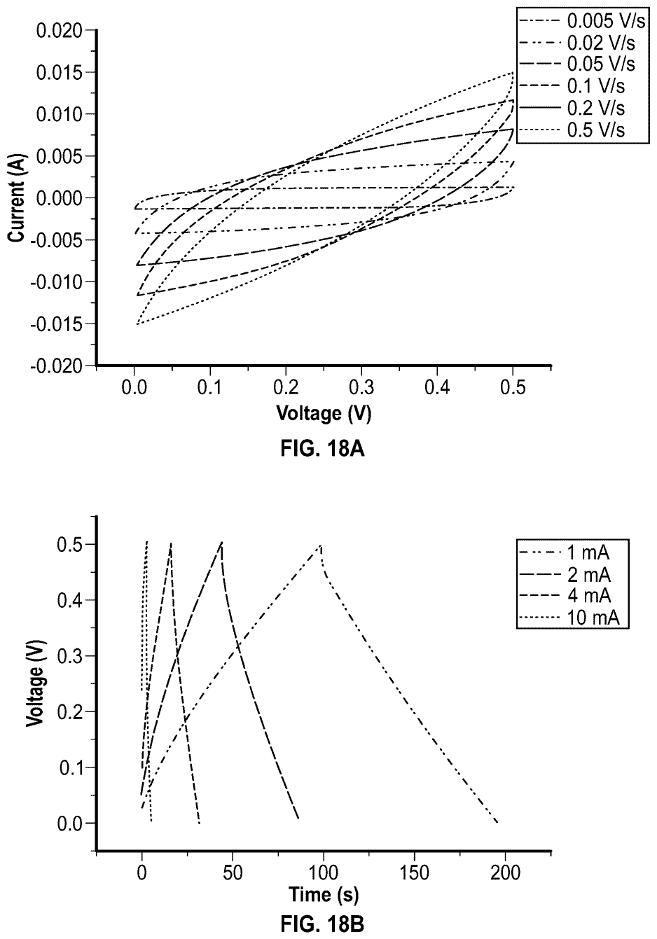

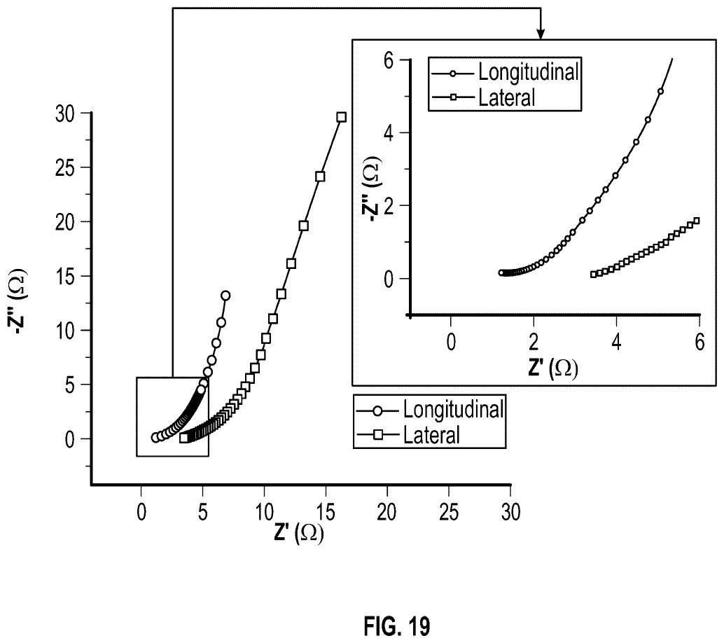

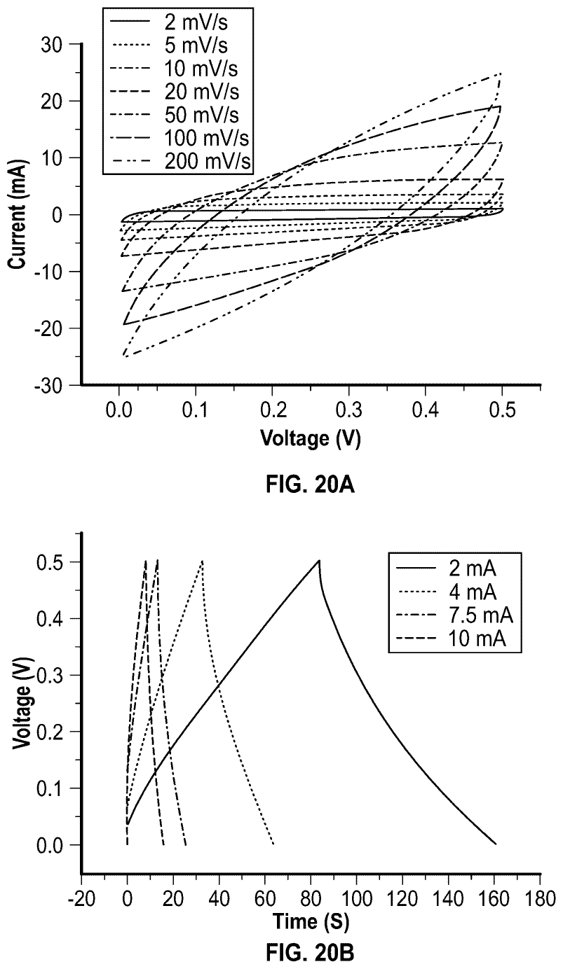

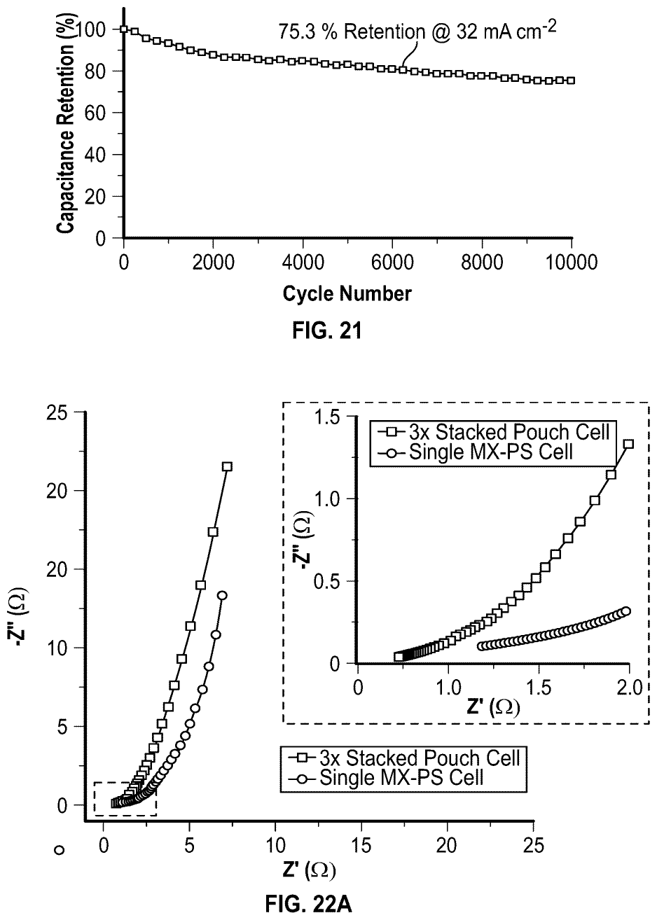

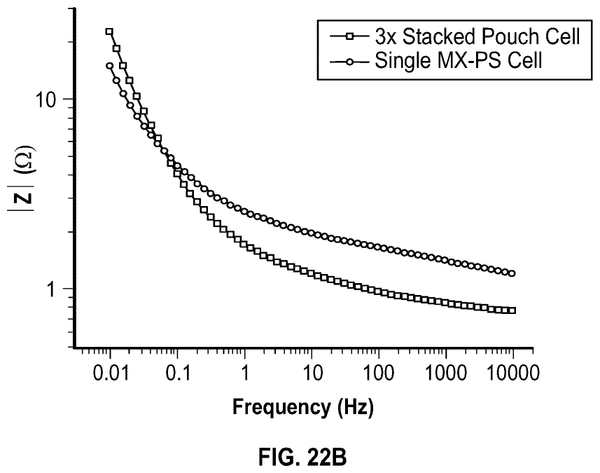

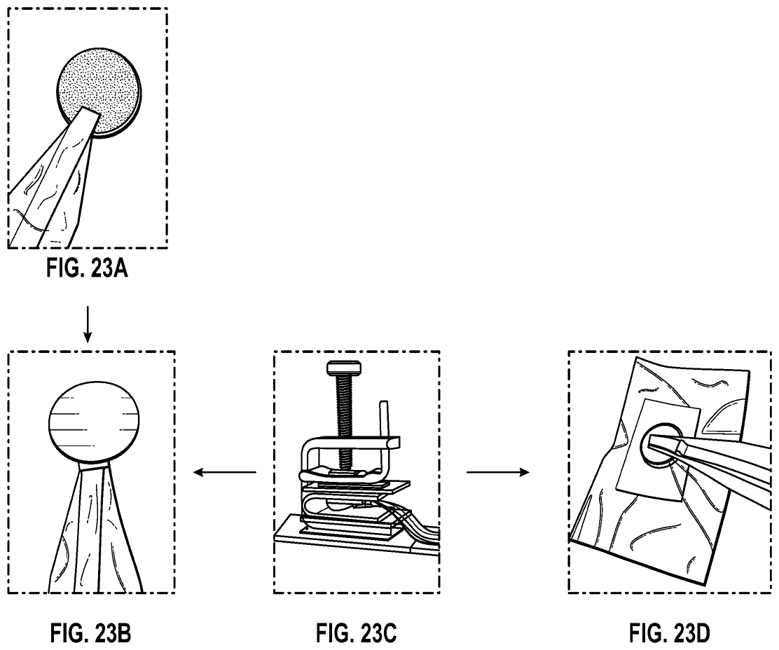

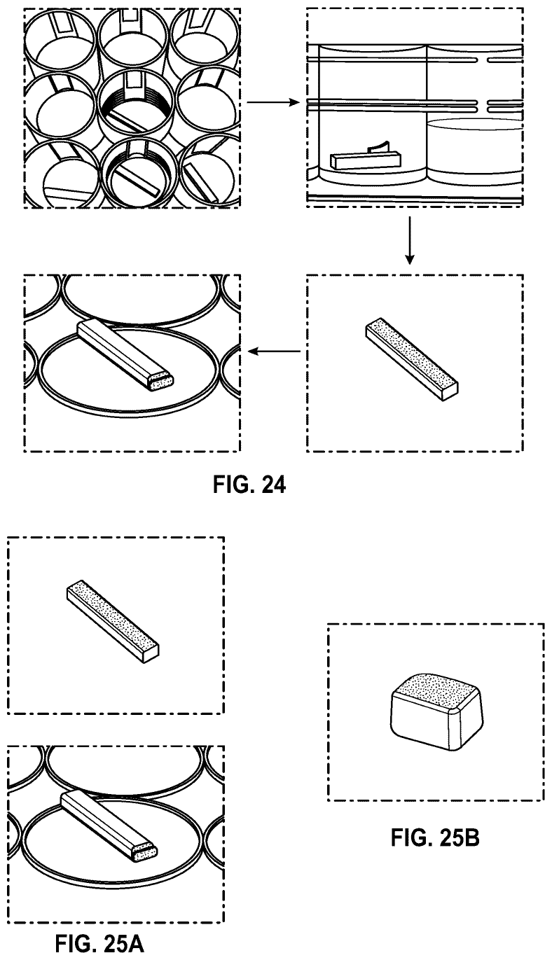

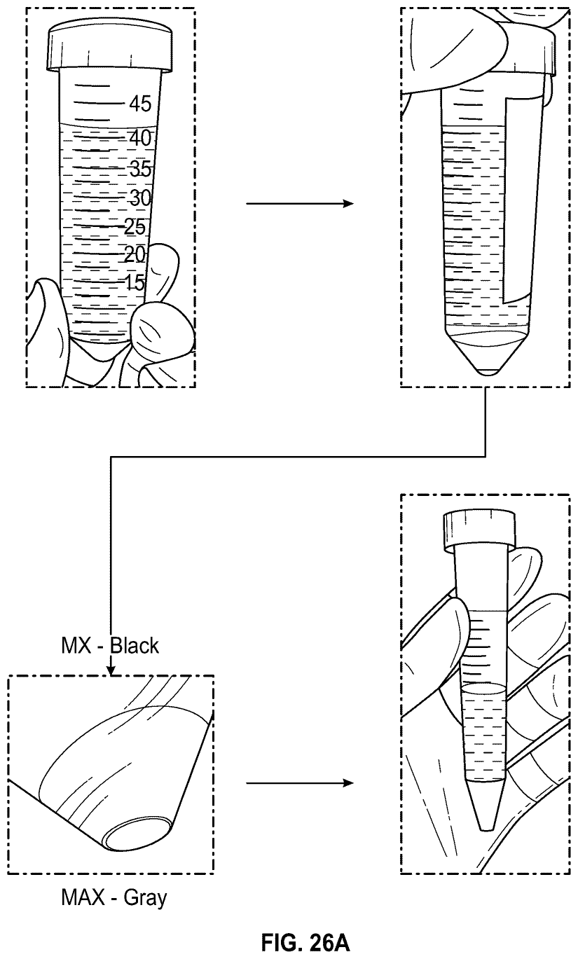

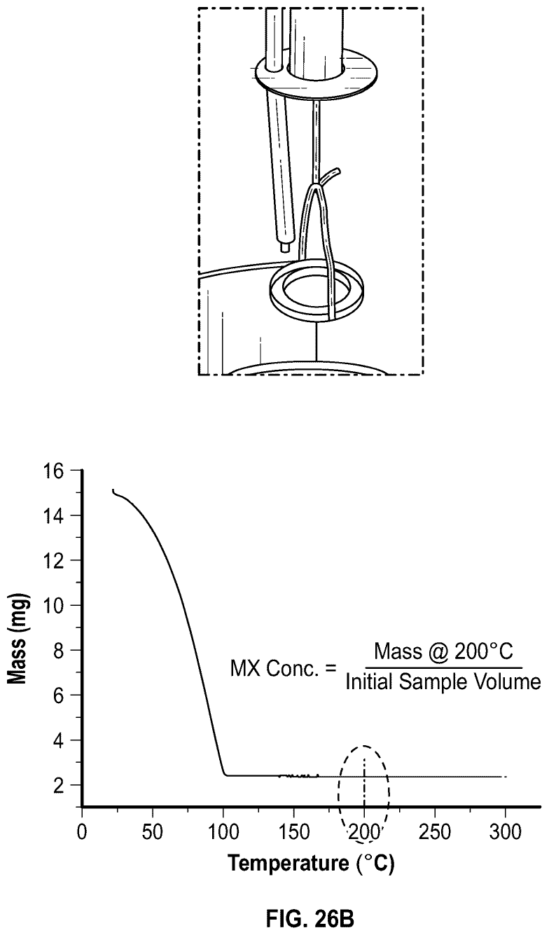

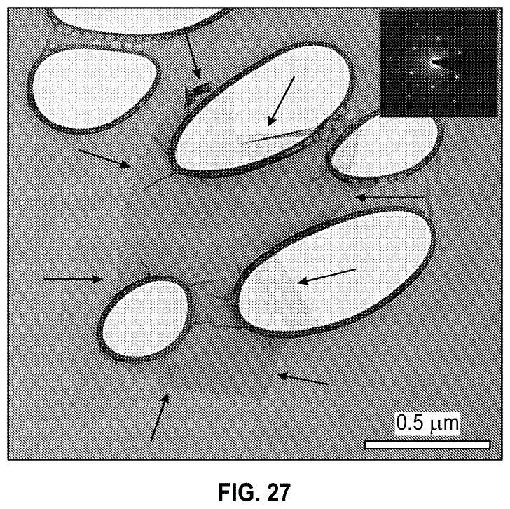

The resulting porous silica backbones may exhibit 60% porosity with 50 μm average pore size. The resulting pores may be observed from the cross-sectional images in FIG. 2a; and FIGS. 8a, 8b, and 9a. The distributions for the equivalent pore diameter in the horizontal cross-sections, the maximum Feret diameter in the vertical cross-sections, and the pore orientation are shown in FIG. 8c,d, respectively. The ratio of open porosity of porous silica samples may be greater than 99.5% using Archimedes' method.

Freeze casting may utilize highly anisotropic solidification characteristics of a liquid (solvent) to template a hierarchical porosity, as illustrated by the scanning electron microscopy (SEM) images in FIG. 1a; and FIG. 8. The pore shape may be related to the solvent used, such as Camphene, water, mixtures of water and glycerine, etc. Each solvent may result in a different pore shape. For example, water may provide more columnar (lamellar) pore structures.

The overall porosity and average pore size may be primarily controlled by the solid loading of the initial slurry, whereas the pore morphology may be determined by the material system, primarily by the solvent. For the same solid-loading level, the dendritic porosity created by camphene-based slurries may result in a higher geometric surface area than the lamellar porosity created by water-based slurries. For this reason, camphene may be utilized as the solvent. The primary orientation of the templated porosity may be dictated by the thermal boundary conditions applied during solidification. In camphene-based systems with unidirectional freezing (i.e., using a low-temperature system on one side), the freezing process may form highly elongated dendrites oriented normal to the freeze front. Perpendicular side branching of dendrites may enable the formation of a 3D network comprising internally connected channels.

The capillary coating of MXene onto surfaces of pores inside the silica backbones may be accomplished by infiltrating aqueous ThC2Tx MXene dispersions and vacuum-assisted drying. The single and multilayer MXene nanosheets may be suspended in the aqueous dispersions by an equilibrium of electrostatic, van der Waals, and hydrodynamic forces. The backbones may be then submerged into the MXene dispersions and refrigerated in sealed vials for 12 hours to enable dispersion to penetrate the porous backbones fully through capillary flow and diffusion. The purpose of refrigeration may be to minimize the oxidation of MXene during the process. The samples may be dried and their external surfaces may be cleaned of excess MXene using damp foam-tipped swabs.

FIG. 7 describes the effect of the MXene concentration in the dispersant and the number of infiltration cycles on the mass of elongated cuboid-shaped porous silica samples (1 mm×1 mm×10 mm) with 60% porosity at different steps of the infiltration and surface cleaning processes.

Cross-sections of MX-PS samples may be analyzed using SEM and energy-dispersive X-ray spectroscopy (EDX), as shown in FIG. 2; and FIG. 9. The SEM images and EDX mapping show the pore surfaces coated with a thin layer of MXene nanosheets and no blocking of pore access by the MXene sheets. The typical dendritic pore morphology may be unchanged during the infiltration, as shown in the longitudinal cross-section at the mid-plane of an MX-PS sample in FIG. 2a. Higher-magnification SEM images, as given in FIG. 2b, show the 3D structure of thin and continuous MXene coating (purple) conformal to the pore surfaces of silica (orange). The texture difference between the MXene nanosheets (smooth) and the sintered silica particles (rough) is illustrated in the grayscale SEM images. The different elements in these regions may be identified by X-ray mapping, and the microstructure of the MX-PS may be further clarified with the help of the unique color labeling of EDX.

In this infiltration approach, the 2D ThC2Tx MXene nanosheets having a high aspect ratio, indicating material possess much larger lateral size compared to its thickness, may be transported into the 3D pore network by the hydrodynamic flow, supported by the capillary effect. To ensure the successful infiltration of the porous backbone, a gentle vacuum pressure may be applied for 10 min during the process. This step may facilitate the removal of any potentially trapped air bubbles that may compromise the quality and uniformity of thin-layer MXene coating. Establishing a well-connected MXene network may benefit from comprehensive infiltration of the dispersion into the porous backbones.

During drying, the free surface of the infiltrant (i.e., the concave meniscus of MXene dispersion inside pores) may progress inwards along the pores as the water departs the backbone through evaporation. The shape and motion of the meniscus within the pores may be controlled by the balance between evaporation and hydrodynamic flow. While the evaporation may cause solid accumulation on the channel surface, the hydrodynamic flow within the MXene dispersion may homogenize the MXene concentration around the free surface by compensating for the evaporated liquid. During drying, the contact line, i.e., the triple interface between the liquid infiltrant, pore surface, and air, may become pinned to the surface until the final evaporation stage. Near the contact line, evaporation may be faster due to the higher curvature of the meniscus. The MXene dispersion may flow internally toward the contact line to replenish this region. However, the higher evaporation

rate near the contact line may create a thermal gradient that lowers the surface tension, resulting in Marangoni flow in the opposite direction toward the center. Usually, the outward flow (from the center of the channel to the contact line) may be more dominant for spherical particles. Through this flow, more particles may be carried toward the contact line and an excessive accumulation near the contact line may be observed, also known as the coffee-ring effect. However, the shape of particles may change the flow dynamics and particle deposition during drying. Primarily determined by the electrostatic forces, strong long-ranged interactions between 2D MXene nanomaterials in water weaken the outward flow, which may help to mitigate the coffee-ring effect caused by excessive accumulation of particles near the contact line. Instead, a thin and uniform MXene film may be obtained with unobstructed pore access upon drying.

Upon completion of the drying process, the ThC2Tx MXene nanoflakes may adhere to both the (silica) pore surfaces and neighboring MXene flakes enabling the formation of a stable and well-anchored MXene coating on the backbone. Note that well-adhered silica nanoparticles may be grown on MXene flakes. The average adhesion energy between a single layer of ThC2Tx MXene and the oxidized layer of a silicon wafer may be 0.90 J m² as measured by direct atomic force microscopy.

The process according to the present disclosure comprises heating the green silica samples to 1200 °C, however, the chemistry of the silica surface may be different compared to the silica, thus providing a different surface interaction with MXene. The mechanical interlocking between the MXene flakes and the surface, resulting from the surface roughness, may further promote this adhesion (FIG. 10a). In some instances, as seen in FIG. 10b, the MXene sheets may adhere to the protruded silica particles, cantilevering out of the local surface. As observed in FIG. 2; and FIGS. 9 and 10 (and confirmed by SEM images), however, a vast majority of the MXene flakes may adhere conformally to the interior pore surfaces of the silica backbone. Note that capillary flow and diffusion limits during infiltration may create a depth-dependent variation in the conformal MXene thickness. Although direct and quantitative data on the uniformity of the MXene layer may be challenging, it is believed that restacking of MXene nanosheets may be minimized based on electrical conductivity measurements, large internal surface area, and SEM images. The MXene coverage via conductivity measurements is described below.

One potential concern about using an aqueous dispersion for MXene may be oxidation. Increased oxidation triggered by the water phase of the mixture may considerably diminish MXene's electrical properties with time. However, unagitated MXene dispersions may exhibit a decrease in oxidation rate at concentrations above a threshold value due to steric shielding. This may arise from overlapping edges of adjacent nanosheets within the dispersion and create a physical barrier (capping and steric shielding) that reduces/prevents water access to the edges of the MXene sheets, slowing down their oxidation, when the concentration of MXene dispersion is above the threshold value. Here (e.g., 1 μm flake size, 1 nm flake thickness, and 3.7 g cm-³ ThC2Tx MXene density), the threshold MXene concentration that minimizes oxidation of MXene in the dispersion may be 7.8 mg/mL. Since the dispersions may have higher concentrations than this threshold value and may be used immediately upon synthesis, the oxidation of water-dispersed MXene may be minimized.

Conformally attaching MXene sheets to the connected network of pores inside the silica backbone may create a 3D assembly of the 2D MXene nanosheets. Through the capillary coating process, the MXene utilization may be enhanced as the dispersed 2D ThC2Tx nanosheets are coated on the internal pore surfaces of the backbone. Since the nanosheets may be spread out over an expansive surface area provided by the hierarchically porous silica, the number of restacked nanosheets may be minimized. Limiting restacking may be important for obtaining optimal electrical properties of MXene to enable important potential applications, such as energy storage systems.

Moreover, the MXene utilization may be further increased by manipulating layer-to-layer interactions within the dried thin film on the pore surfaces. For example, adding nanoparticles (OD), nanofibers (1D), or 2D nanoflakes as physical separators, or tailoring the functional groups on MXene surfaces chemically, such as by growing black phosphorus on MXene, may mitigate restacking within such confined spaces.

The fabrication parameters used for creating the MX-PS samples may directly affect their electrical conductivity. The preparation of MX-PS samples comprises: fabricating silica backbones having controlled porosity using the freeze casting process; synthesizing MXene and preparing the dispersion having the desired MXene concentration; and infiltrating the MXene dispersion into the backbones and drying. Within each step, multiple factors may be sed to tune the spatial distribution of the MXene network and, thus, the electrical conductivity of the final MX-PS parts. The effects of the MXene concentration of the dispersions, the number of infiltration cycles, and the porosity and pore orientation of backbones on the conductivity of MX-PS samples is described. Furthermore, the effect of the storage time (i.e., the time elapsed since the fabrication of MX-PS parts) on the electrical conductivity of the samples is also described.

Here, the effect of MXene concentration in the dispersion on the electrical conductivity of the MX-PS samples is evaluated. In electronics applications, silica may be used as an electrical insulator due to its low conductivity of 5×10-¹² Siem at 300 K. The thin-layer coating of the interconnected network of MXene nanosheets on the internal pore surfaces of the silica backbones may make the MX-PS samples electrically conductive. To assess the effect of MXene concentration on electrical conductivity, in addition to the MXene dispersion with 180 mg/mL concentration, dispersions with concentrations of 45, 90, and 135 mg/mL may be prepared.

As seen in FIG. 3a; and FIG. 11a, the electrical conductivity of MX-PS samples may increase by more than 30 folds as the concentration of the MXene dispersion is increased from 45 mg/mL (1 vol %) to 180 mg/mL (4 vol %). Electrical conductivity as high as 100 S/m may be obtained for single infiltration of 180 mg/mL MXene concentration. To assess the reproducibility, three samples may be tested for each concentration level having relatively low variability in the conductivity of samples prepared nominally under the same conditions, especially at higher concentration levels. The increase in conductivity with MXene concentration may be nearly exponential up to 135 mg/mL, but the rate of increase may be lower at higher concentrations (from 135 to 180 mg/mL).

Without wishing to be bound to any particular theory, it is believed that the increased conductivity obtained at a higher concentration MXene dispersions relates to the infiltration with higher MXene concentrations makes a larger number of nanosheets available for establishing a better-connected network. In addition, the concentration gradient between the infiltrant bath and the center of the backbones may increase with an increase in MXene concentration. Based on Fick's law of diffusion, this increased gradient may impose a higher diffusion flux for MXene nanosheets to infiltrate the porous backbone. This may facilitate faster and easier infiltration of MXene nanosheets into the substrate pores, resulting in a more uniform and well-connected network. These synergistic effects may enhance the overall electrical conductivity of the resulting MX-PS composite.

At lower MXene concentrations, the conductivity may exponentially increase increased concentration. The rate of increase in conductivity may diminish at higher MXene concentrations, as shown in FIG. 3a. The conductivity improvement in percolation-based systems may be expected to converge to a saturation limit. With further concentration increases, the probability of forming additional conductive paths may decrease, and the improvement in conductivity may become less significant. In addition, at higher concentrations, the viscosity of the MXene dispersion may increase rapidly, limiting the ability of the dispersion to penetrate and uniformly coat the substrate. This may result in a nonuniform infiltration of MXene within the substrate and a less connected conductive network, leading to a saturation limit in conductivity improvement with increased MXene concentration. The dispersions according to the present disclosure may comprise exfoliated single-layer and delaminated multilayer ThC2Tx MXene flakes. The viscosity of a multilayer MXene dispersion may be 0.350 Pas at a shear rate of 0.01 s-¹ when the volume fraction is 0.027, which may be within the volumetric concentration range of 0.01-0.04. The viscosity may increase exponentially with MXene concentration, limiting the infiltrant's mobility into porous silica. Hence, the preparation of MXene dispersions with concentrations higher than 180 mg/mL to further increase the electrical conductivity may be challenging due to the high viscosity of the dispersion.

The electrical conductivity of the MX-PS samples may be increased by circumventing the high-viscosity limitation by using multiple infiltrations. The backbones may be infiltrated multiple times using the MXene concentrations of 180 mg/mL and 90 mg/mL. As illustrated in FIG. 3a; and FIG. 11b, when the dispersion with 180 mg/ml MXene concentration is used, the conductivity may increase more than three folds, reaching 340 S/m in three infiltration cycles. However, subsequent infiltration cycles may not increase the conductivity further; indeed, a slight decrease in conductivity may be observed. For a MXene dispersion at 90 mg/mL, the conductivity may increase from 18 to 51 S/m after nine infiltration cycles as shown in FIG. 11c. The rate of increase and the final value obtained when the conductivity converged to its maximum may be both significantly lower for 90 mg/mL as compared to those for 180 mg/mL.

The increased conductivity with multiple infiltrations may arise from at least one of the following mechanisms: higher network connectivity obtained by coating the uncoated surfaces with MXene and stacking an increased number of MXene layers on already coated surfaces. Both mechanisms may play a role in the increased conductivity. Without wishing to be bound to any particular theory, the “saturation limit,” i.e., the limitations to increasing the conductivity beyond a certain level, may also be explained by several mechanisms. First, the water content of MXene dispersion may bring hydroxyl groups that accelerate the oxidation of the previously coated layer, thereby reducing the conductivity. Second, once the percolation threshold is established, the quality of the network may not be improved further. Third, the subsequent infiltration cycles may detach some of the previously deposited MXene layers. Fourth, the increased thickness of MXene layers may obstruct some of the smaller pores, limiting the penetration of further MXene. However, considering the low thickness of MXene layers and the SEM observations, pore obstruction may not affect subsequent infiltrations. And fifth, smaller pores may lead to diminished local capillary mobility due to reduced Reynolds number for the fluid flow, preventing/reducing local wetting. The limited utilization of the backbone's porosity and surface area due to high viscosity may lower the saturation limit.

The infiltration depth of MXene into the porous silica backbone may be relevant to the length scale of the current work. Cube-shaped MX-PS samples having an edge length of 10 mm, which is roughly ten times larger than the thickness of the MX-PS electrodes described below may be infiltrated. Both single and multiple (five) infiltration cycles may be applied to capture the effect of infiltration cycles on MXene concentration with depth. FIG. 12a,b shows the SEM images of the single-infiltration case, where a section at the center (5 mm inside) of the sample is indicated. The major pore direction (and, thus, the main infiltration direction) is indicated by the arrows on the images. FIG. 12c shows the associated EDX analysis of the indicated sample section, where the detected Ti shows the presence of MXene. FIG. 12d-f shows the corresponding images for the sample having five times MXene infiltration. Ti (and, thus, MXene) is detected 5 mm inside the sample. Note also that larger samples may require longer infiltration times. The MXene may penetrate porous silica samples at least to a depth of 5 mm for both the single and multiple-infiltration cases. At least 50%, 75%, 80%, 90%, 92%, 95%, 98%, or 99% of the interior surface is coated.

The conductivity of the MX-PS samples may change with the storage time. The conductivity of three MX-PS samples is measured weekly for 6 weeks. During this time, the samples are stored under low pressure (120 mbar) at 4 °C except when measuring the resistance. As shown in FIG. 3c, the conductivity exhibits some decay with time. By Week 6, the electrical conductivity of MX-PS samples decreases and converges to 70% of their respective initial value. The decay in the conductivity of the MXene aerogel (the synthesis of which is described in the Experimental Section) molded in a prismatic shape with 1 mm×1 mm×10 mm dimensions is measured, where the conductivity is measured along the long direction. As shown in FIG. 13, relative to the reduction in conductivity of the MX-PS samples, about three times faster degradation is observed for the MXene aerogel after one week (60% reduction in conductivity for MXene aerogel vs 20% for MX-PS samples).

Without wishing to be bound to any particular theory, it is believed that the observed reduction in conductivity is related to the oxidation of MXene sheets. The 2D MXene nanosheets on pore surfaces may be prone to oxidation due to the available hydroxyl anions in the environment. These anions may interact with the MXene nanosheets through the voids between the flake layers inside the thin surface coating and the carbon vacancies within flakes originating from the source material. The oxidation stability may be improved by controlling the temperature and exposure to oxygen or water molecules. Although the samples are stored under low pressures, there may be a considerable number of oxygen molecules at these vacuum levels, which may cause the oxidation of MXene sheets. Sealing the outer surfaces of the MX-PS samples or filling the samples with a tertiary material (e.g., an elastomer) may minimize oxidation.

The electrical conductivity of MX-PS samples may also depend on the porosity and/or pore-size distribution of the backbone since the amount and network connectivity of MXene may be a direct function of the internal area and pore connectivity. The 3D surface interactions between the silica surface and the 2D nanosheets that conform to the internal pore walls may provide the structural stability of the conductive MXene network within the samples. Therefore, controlling the porosity of the backbones may be important for successful infiltrations of MXene, and hence, higher electrical conductivity. To evaluate the effect of the backbone's porosity on the conductivity of the MX-PS samples, six sample backbones with 40% and 60% porosity, obtained by using silica solid loading of 40% and 20% during freeze casting, respectively, are tested. As shown in FIG. 3d, for 180 mg/mL MXene concentration, reducing the porosity from 60% to 40% causes a fivefold reduction in the conductivity of the MX-PS samples.

This substantial decrease in conductivity may arise primarily from the reduced internal surface area of the lower-porosity backbones. The increased solid loading also may result in smaller pore sizes and narrows the pore size distribution. Increasing the silica solid loading from 20% to 40% may decreases the average pore size in the backbone from 50 μm to 20 μm. Considering the viscosity of the MXene dispersions and the size of MXene nanosheets, the reduction in pore size may reduce the infiltration efficiency. The capillary action may draw water into smaller pores while leaving the MXene nanosheet behind, creating a phase separation. These findings highlight the ability to modulate

the MX-PS properties (here conductivity) via selecting one or more process parameters, such as solid loading, to generate a material having desired material characteristics.

The pore orientation when the MXene network forms within the backbones may significantly impact electrical conductivity on pore orientation. The electrical conductivity of the MX-PS samples with different pore orientations was measured to characterize the effect of pore orientation. For this purpose, cuboid-shaped MX-PS samples with 10 mm length were prepared, and the resistance was measured along (longitudinal) and normal to (lateral) the primary pore orientation, see FIG. 3b. We observed that the electrical conductivity for longitudinal pore orientation was approximately an order of magnitude higher than that for the lateral pore orientation. Furthermore, this significant effect of pore orientation was present at different MXene dispersion concentrations (90 and 180 mg/mL) and different backbone porosities (40% and 60%).

Unidirectional freeze casting using a camphene-based solvent templates a dendritic and hierarchical porosity within the silica backbones. The primary dendrite growth direction determines the primary pore orientation; in unidirectional freezing, the primary dendrite direction (i.e., the “trunks” of the tree-like shapes) may be aligned with the thermal gradient (i.e., perpendicular to the freeze front). This result may be explained by considering the MXene network established within the freeze-cast backbones. Thus, a more direct connection of the MXene network along the primary pore orientation may be established. The internal surfaces of the anisotropic porosity may provide the pathways for creating an aligned interconnected network of MXene, which may be important for obtaining high electrical conductivity. Additional connections between the main channels may be obtained by the side channels (formed by the side branching of camphene dendrites during solidification), strengthening the MXene network. To quantify the mechanical advantage provided by the freeze-cast silica to the infiltrated MXene, compression tests may be carried out on the silica backbone samples (the testing procedure is described below. For comparison, fabricated freeze-dried MXene aerogels may be subjected them to compression under identical conditions. FIG. 14 shows a representative engineering stress, a strain plot for 60% nominally porous freeze-cast silica (compressed along the freezing direction) and the MXene aerogel (the experiment is repeated on at least four different samples, each producing similar results). The average compressive strength of the silica backbone is 1.9 MPa, and the average compressive strength of the MXene aerogel is 1 kPa. The strength enhancement by arranging MXene in the silica backbone may be over 3 orders of magnitude. The elastic modulus of the porous silica backbone is 50 MPa, while that for the MXene aerogel is 6.5 kPa. Thus, a significant mechanical advantage may be obtained via the 3D arrangement of 2D MXene flakes using freeze-cast porous silica backbone.

The pore size, pore elongation, and side branching may be controlled by the initial solid loading and freezing direction, which may be controllable freeze-casting parameters. The elongation and orientation of the pores may be described by their Feret properties, which describe the morphology of the interconnected porosity. Thus, the anisotropic electrical conductivity may be controlled by these morphological porosity parameters of the freezecast backbone. Therefore, highly anisotropic or isotropic electrical conductivity in MX-PS samples may be generated by selecting the porosity distribution. The isotropic porosity may be obtained by establishing omnidirectional freezing, e.g., submerging the slurry into a cooling bath.

Referring to FIG. 4a, to demonstrate the utilization of electrically conductive MXPS samples in a case study, sandwich-type (or button-type) two-electrode supercapacitor assemblies that use disk-shaped MX-PS free-standing electrodes in a symmetric arrangement may be manufactured.

Backbones having 60% porosity and infiltrated them with 180 mg/mL MXene dispersions may be used. To show the effect of MXene infiltration, a capacitor with the same design using non-infiltrated silica backbones as electrodes may be manufactured; this supercapacitor may be referred to as a “non-MXene supercapacitor.” To assess the electrochemical performance of the supercapacitors, electrochemical impedance spectroscopy (EIS), cyclic voltammetry (CV), galvanostatic charge-discharge (GCD) tests, and calculated their capacitance (see the Experimental Section for details) may be analyzed.

The results of CV at scan rates of 2, 5, 10, 20, 50, 100, and 200 mV s-¹ are shown in FIG. 4b for the supercapacitor with MX-PS electrodes. The responses in the positive and negative sweep regions of the CV curves are symmetric at every scan rate, suggesting a reversible charge-discharge behavior. The maximum currents, recorded at the boundaries of the selected potential window, show a notable increase with scan rate while the overall shape of the curves remains unchanged. FIG. 15a shows the significant difference in CV curves for the MX-PS supercapacitor and non-MXene supercapacitor at a scan rate of 10 mV-s i.

Due to rapid Faradaic surface reactions, pseudocapacitive materials, such as MXene, may offer much higher capacitance and rate capability (i.e., an ability to charge and discharge at different current densities) relative to electric-double-layer capacitors (EDLC), which may rely only on the capacitive charge storage at the electrode, namely, electrolyte interface. Therefore, the strong performance of MX-PS supercapacitors may relate to pseudocapacitance. Referring to FIG. 4e, the thin MXene coating on the internal walls of freeze-cast silica may enable electrons from the current collector to travel freely and cover a larger surface area. Thus, the porous structure may be better utilized, and the active zone may be expanded, enhancing the mobility of anions/cations in the electrode material. The higher number of electrons on the porous electrode surface may attracts more ions from the neighboring electrolyte, increasing the effective surface area and the electrochemical double-layer capacitance during fast charge, namely discharge processes. Therefore, the electrochemical performance of the MX-PS supercapacitors may be considerably better than that of the non-MXene supercapacitors.

The GCD measurements for the MX-PS supercapacitor are shown in FIG. 4c at different

current densities. A comparison of the GCD curves of the MX-PS supercapacitor and non-MXene supercapacitor is shown in FIG. 15b at a current density of 2 mA cm-², highlighting the significantly
enhanced performance of the MX-PS supercapacitor. The GCD curves of MX-PS supercapacitors show a quasi-triangular shape with a symmetric charge-discharge behavior. The MX-PS supercapacitor may exhibit an almost linear discharging curve, indicating a consistent and predictable discharge behavior, likely associated with the pseudocapacitive behavior. The discharge duration may be long due to improved charge storage capacity and pseudocapacitance of ThC2Tx MXene in acidic (H2SO4) electrolytes. Also, the MX-PS supercapacitor may have a minor voltage drop, referred to as the IR drop, in GCD curves at the beginning of the discharge cycle. The IR drop may be related to the internal resistance of the supercapacitor, and a small IR drop may indicate a low internal resistance of a supercapacitor, desirable for efficient energy storage. These characteristics of MX-PS supercapacitors may enable achieving high current densities of up to 30 mA.

FIG. 4d shows the Nyquist plot showing the results of the EIS for the MX-PS supercapacitor. The results in the high-frequency region of the Nyquist plot indicate that the MX-PS supercapacitor has good electrical conductivity; this may indicate a low internal resistance, confirming the small IR drop observed in the GCD curves. The internal resistance of supercapacitors may be calculated by adding the resistances of the electrode, the electrolyte in the porous structure of the electrode, and the contact resistance between the electrode and the current collectors. The high metallic conductivity of MXene and the well-connected MXene network on silica backbones may lower the internal resistance significantly. A lower internal resistance may reduce the energy loss via heat generation during charge-discharge cycles, enhancing the electrochemical performance. At the low-frequency range of the Nyquist plot, the MX-PS supercapacitor may exhibit a steep slope, indicating an ideal capacitive behavior. The amplitudes of the impedances for MX-PS and non-MXene supercapacitors are shown in FIG. 15c, revealing a dramatic difference between the two.

The areal and gravimetric capacitances of the MX-PS supercapacitor may be calculated from the CV curves at a scan rate of 10 mV s-¹ as 7.24 F cm² and 7.26 F g-i, respectively. These results

are obtained using infiltration with the MXene dispersion of 180 mg/mL concentration, resulting in an active (MXene) mass loading-MXene-to-backbone mass ratio-of 6%. The mass increase in porous silica may be due to MXene infiltration is given in FIG. 7 and FIG. 16. Also, the effect of MXene concentration on the electrochemical performance may be briefly evaluated by comparing these results with the ones of a supercapacitor prepared with a reduced MXene concentration of 90 mg/mL.
The calculated areal capacitance for the MX-PS supercapacitor may be prepared with the MXene concentrations of 90 mg/mL is 3.13 F cm², at the scan rate of 10 mV s-¹. The corresponding CV and
GCD results are shown in FIG. 17. Overall, the electrochemical performance of the MX-PS supercapacitor may be tuned by changing the input parameters to the system such as the MXene concentration during infiltration.

The effect of porosity on the areal and gravimetric capacitances of the MX-PS supercapacitors is shown in FIG. 4f. MX-PS electrodes from silica backbones with 40% and 60% (longitudinal) porosity are infiltrated with the MXene dispersion of 180 mg/ml concentration and are assembled into supercapacitors. The capacitance values are then calculated from the CV curves obtained at a scan rate of 10 mV-s i. The capacitance may increase four folds when using electrodes with 60% porosity than with 40% porosity. This significant effect may be explained by the increased average pore size and total pore volume of higher-porosity backbones, enhancing pore accessibility, and facilitating the infiltration of MXene nanosheets. Also, the difference in the gravimetric capacitances may be due to porosity is relatively larger than that in the areal capacitances. Lower porosity may be reduce MXene infiltration and increased total mass for the same projection area. The corresponding CV and GCD curves for the supercapacitor with the 40% porosity electrodes are shown in FIG. 18.

The effect of pore orientation of the MXene infiltrated electrodes on the electrical performance of the supercapacitors may be investigated using electrodes with 60% porosity. Electrodes with longitudinal and lateral pore orientations may be used in separate supercapacitor assemblies. Although the total pore volume and the average pore size may be the same for the electrodes, the electrodes with longitudinal porosity (i.e., pores mainly oriented toward the counter electrode) may produce nearly three times higher capacitance than those with lateral porosity. This may be related the conformal MXene network that forms inside the porous samples. For electrodes with longitudinal porosity, the primary pore orientation toward the counter electrode may create a shorter (i.e., more direct) electrical pathway. Considering the anisotropy of pore geometry, the infiltrated MXene network may have better connectivity along the primary pore orientation than the side branches.

However, for electrodes with lateral porosity, the electrical pathway may be formed through the internal connections of the dendritic side branches, creating more tortuous pathways. Therefore, the resistance of the supercapacitor with lateral porosity may be higher than that of the supercapacitor with longitudinal porosity. The Nyquist plots for the two cases are shown in FIG. 19, and the CV and GCD curves for the supercapacitor with lateral pore orientation are shown in FIG. 20.

The cycle life stability of the MX-PS supercapacitors may be demonstrated by using MX-PS supercapacitors having longitudinal porosity and 180 mg/mL MXene concentration and ran up to 10,000 GCD cycles through repeated charge—discharge at 32 mA cm-² current density, as shown in FIG. 21. The capacitance retention of the MX-PS supercapacitor is 75.3%, after 10,000 cycles. This performance is sufficient for MXene-based supercapacitors, but may be further improved. For example, the current density used in the cycling test is 32 mA cm-², whereas the lowest value we tested in the GCD experiments is 2 mA cm-², as shown in FIG. 4c. Using a lower current density may improve the cycling stability of supercapacitors by reducing the likelihood of damage or

degradation to the electrode and electrolyte materials and minimizing heat generation. Carrying out tests in inert environments may be reduce oxidation-driven degradation. Additionally, the cyclic-charging results of supercapacitors may vary by the pH of the electrolyte (acidic vs neutral), the size of the MXene nanosheets, and the interlayer spacing of MXene. For instance, MXene nanoparticles, polyaniline nanofibers (PANINFs), or cellulose nanofibrils (CNFs) may be used to control the interlayer spacing while providing additional structural stability and minimizing the restacking of 2D MXene nanolayers.

Areal capacitance may be used to evaluate the electrochemical performance of the MX-PS supercapacitors. Areal capacitance may express the electrochemical performance of a supercapacitor for the projected device area; a high areal capacitance may be preferred in electronic device applications. FIG. 5a,b shows the reported areal capacitances of MXene-based electrodes as a function of MXene mass loading from the literature, including supercapacitors based on 3D Na-MX,

MX/WOx, MX/PANI, MX/SA-5, MX Aerogel, 3DP MX, Extruded MX, MX/MnO2, and MX Clay. The MX-PS electrodes show excellent areal capacitance of 7.24 F cm-² with 2.4 mg cm-² ofThC2Tx
MXene, indicating effective MXene utilization. Based on the infiltration approach, the dispersed MXene nanoflakes, which may otherwise form a dense restacked film, may be diffused into the pores spreading out over the large surface area of the porous backbone. This process may increase the area of the exposed individual MXene flakes for electrochemical reactions, enabling better utilization of MXene and improved performance of MX-PS supercapacitors, as shown in FIG. 5a,b.

The MX-PS supercapacitors' areal energy density and areal power density may be calculated. They produce an areal energy density of 0.32 mWh cm-² and an areal power density of 4.57 mW cm-² at a current density of 2 mA cm-². At an increased current density of 32 mA cm-², the power density increases to 65.31 mW cm-², while the energy density decreases to 0.09 mWh cm-². As shown in the

area-normalized Ragone plot in FIG. 5c, these values may be higher than the values for MXene-based sandwich-type supercapacitors, including symmetric TDVW-9, symmetric MX/MPFs-^{6:1}, asymmetric MX/Fe-15%//MnO2/CC, asymmetric ThC2 MX aerogel//ESCNF, and symmetric 3D Na-MX. Five MX-PS supercapacitors may be connected serially, after charging each up to 0.5 V, to an LED light with an operating voltage of 2.5 V. The supercapacitors successfully power the LED, as shown in FIG. 5d.

To further demonstrate the scalability of this approach according to the present disclosure, a triple-stack pouch cell using our MX-PS electrodes may be constructed and assessed its electrochemical performance. A schematic illustration of the pouch-cell assembly is shown in FIG. 5e, and the optical images of the assembled pouch cell are shown in FIG. 5f. The pouch cell comprises six MX-PS samples useful as two double-sided and two single-sided electrodes. The electrodes may be separated by electrolyte-soaked porous polypropylene membranes. FIG. 5g shows the CV curves of the single MX-PS supercapacitor and the stacked pouch cell at a scan rate of

10 mV s-¹ in a potential window of 0-0.5 V. Similar to that for a single cell, a typical pseudo rectangular shape is observed for the pouch cell. The area under the curve of the stacked pouch cell may be considerably higher than that of the single cell, demonstrating that the stacked device contains more electroactive species and thus provides an extra charge for the storage mechanism. As shown in FIG. 5h, the discharge duration may increase threefold with the stacked configuration compared to the single cell, indicating a threefold increase in capacitance storage. Even though the pouch cell comprises a larger contact area due to multiple interfaces between the MX-PS electrodes and the separators, linear and symmetrical charge-discharge behavior may be preserved with a negligible IR drop. Additionally, EIS is conducted to assess the resistivity of by the pouch cell. As shown in the Nyquist plot depicted in FIG. 22a, a similar curve may be obtained for the pouch cell with a low resistance value at the high-frequency region and a steep increase in the low-frequency region. The impedance of the pouch cell remains low comparable to that of the single cell over the entire frequency domain tested in EIS, as shown in FIG. 22b.

Referring to FIG. 1a, the pore sizes of the silica backbone may increase as a function of distance from the constant-temperature cooling surface. The sample-to-sample pore diameter variation for the MX-PS samples is less than ±5 μm. For disk-shaped supercapacitor electrodes having a thickness of a few (1-10) millimeters, the performance variation from this factor may be minimal. For electrodes having greater than 10 mm thickness, other processing parameters may be desirable to minimize variations along height. For example, dynamic, constant-flux cooling of the cold surface may generate a more uniform pore size distribution for thicker samples, e.g., a few centimeters in size along the height.

The results discussed above indicate that the electrical and electrochemical performance of MX-PS supercapacitors may be controlled and improved via the manufacturing methods according to the present disclosure by manipulating certain structural and/or chemical characteristics of the MX-PS electrodes. The characteristics of the MX-PS supercapacitor may be optimized by selecting a the optimal pore size distribution and/or maximizing MXene infiltration and reducing restacking.

Comparing the areal energy and power densities of the MX-PS supercapacitors according to the present disclosure indicate stronger performance relative to conventional methods.

The 3D network of nanomaterials described in the present disclosure may be useful for various applications such as batteries, fuel cells, decarbonization systems, and catalytic devices, for example.

The methods of making the 3D MXene network described is this disclosure may generate a conductive 3D MXene network by infiltrating MXene nanosheets into porous silica backbones having controlled porosity. This method may generate 2D MXene nanoflakes to conformally coat the inner surfaces of the backbone's interconnected open pores. This geometry may enable a direct large-area interaction of passing gases with the 2D MXene, which may find applications in decarbonization, catalysis, and/or steelmaking. A dense shell surrounding the freeze-cast samples may reduce/prevent

gas leakage from side surfaces in such applications. The fabricated MX-PS material may also exhibit strong and directional electrical conductivity. In addition, the MX-PS electrodes may be utilized in a range of device configurations (see FIG. 5d-f), including integrated electronic systems, such as high-performance integrated circuits (ICs), and electric vehicles.

One or more of the porosity, pore orientation, concentration of the MXene dispersion (infiltrant), and the number of infiltration cycles may affect the electrical conductivity of the MX-PS material. For example, multiple infiltrations of a higher porosity backbone (60%) having the maximum MXene concentration (180 mg/mL) may be characterized by the highest electrical conductivity (340 S/m) along the primary pore orientation. The method according to the present disclosure may reduce the bulk restacking of ThC2Tx MXene nanomaterials, leading to a more effective utilization of MXenes. Extended storage of MX-PS samples without hermetic conditions may decrease the conductivity due to oxidation; however, a steady state (70% of the initial conductivity) may be reached after several weeks. The MX-PS may be useful for manufacturing symmetric sandwich-type supercapacitor assemblies comprising the MX-PS electrodes. The electrochemical performance of the MXPS may be enhanced due to pseudocapacitance and/or more

effective use of the available surface area by the MXene coated onto the pore surfaces. The MX-PS
supercapacitors may exhibit an excellent areal capacitance (7.24 F cm-²) and a high energy density (0.312 mWh cm-²) with only a small amount of active mass loading (2.43 mg cm-²), indicating
substantial MXene utilization. Note that the mass loading used to assess utilization may be calculated based on the amount of MXene used in (i.e., deposited within) the electrode after the external surfaces of the samples are cleaned (see FIG. 7 and FIG. 16).

The ability to tailor the porosity distribution of the backbone through the freeze-casting process, the MXene dispersions, and the infiltration process may enable controlling the electrical conductivity and electrochemical capacitance of the MX-PS structures. Although ThC2Tx MXene is used as the 2D electronic material and silica for the porous backbones, the method according to the present disclosure may be useful for other 2D and nanoscale materials (e.g., other types of MXene, graphene, carbon nanotubes) and other backbone materials (e.g., other ceramics, polymers), enabling assembling 2D nanomaterials in the 3D space. It is noted, however, that in contrast to MXene, 2D materials, such as reduced-graphene oxide (rGO) and hexagonal boron nitride (hBN), may benefit from specific surfactants to obtain stable aqueous dispersions. The MX-PS samples may also be shaped in multiple configurations such as discs (for supercapacitor electrodes, see FIG. 23), elongated cuboids (for electrical conductivity measurements, see FIGS. 24 and 25a), and cubes of 8-10 mm edge length (for infiltration depth assessment, see FIGS. 12 and 25b). These geometries may be manually cut out of frozen slurry right after solidification using a double-edge razor blade, owing to the butter-like morphology of frozen slurry. Samples with complex geometries may be obtained

using computer-assisted techniques, such as micromachining, or via complex mold structures, enabling their use for different applications.

The systems and methods according to the present disclosure may induce electrical conductivity in nonconductive materials, such as ceramics and polymers. Furthermore, the porous structure of MX-PS may provide the capability to permeate gases or liquids through the structure. The method according to the present disclosure may be scalable leading to cost-competitive processes compared to the current state-of-the-art supercapacitors. For example, a large cold finger, up to a meter square in size, may be used to create thousands of freeze-cast structures shown in FIG. 1a, enabling serial/batch production of backbones. Similarly, the method according to the present disclosure may be useful for scaled, batch-level MXene synthesis and infiltration.

This disclosure introduces a new hybrid material systems that includes a 3D arrangement of nanomaterials on a porous backbone having controlled porosity. Specifically, 2D ThC2Tx MXene nanomaterials may be assembled in 3D space on freeze-cast porous silica backbones through a capillary-driven infiltration approach. In addition to facilitating the 3D arrangement of 2D materials, the porous backbone may be characterized by mechanical strength, electrical insulation, and gas/liquid permeability, all of which may be desirable for electrochemical applications. The microstructure indicates that the thin-layer morphology of the MXene may be conformal to the internal pore surfaces, effectively mitigating restacking of nanoflakes. The hybrid material systems may be characterized by outstanding electrical conductivity that may be finely tuned by controlling the MXene concentration of the infiltrant, the number of infiltration cycles, and/or the porosity of the backbone. In addition, the selective orientation of the pores may enable anisotropic electrical conductivity of the fabricated MXPS electrodes. The MXene-infiltrated porous silica electrodes integrated into sandwich-type supercapacitors may produce a strong electrochemical performance, demonstrating the exceptional utilization of MXene. The methods according to the present disclosure may widely apply to other 2D and nanoscale materials, such as graphene or carbon nanotubes, and other backbone materials, such as ceramics, metals, or polymers, enabling a broad range of emerging and novel applications that utilize the novel material system introduced in this work.

### EXAMPLES

The MXenes (e.g., transition metal carbides, nitrides and carbonitrides) hybrid material systems as well as methods of making and using the same described herein may be better understood when read in conjunction with the following representative examples. The following examples are included for purposes of illustration and not limitation.

Freeze Casting of Silica: FIG. 1a shows the preparation steps of porous silica via freeze casting. First, an anionic dispersant (Hypermer KD-24, Croda, Inc., Princeton, NJ, USA) was mixed with camphene (Cl0H16, CAS79-925, Sigma-Aldrich, St Louis, MO, USA) on a magnetic hot plate at 60 °C for 30 min. Camphene is a nonpolar solvent when liquid and its melting point is 46-52 °C.

Then, preheated silica powder (dso=400 nm, USl 133M, US Research Nanomaterials, Inc., Houston, TX, USA) was gradually added to this mixture of molten camphene and dispersant while being stirred to ensure uniform coverage of the dispersant on the particle surfaces to avoid agglomeration and settling. The ceramic slurry was then subjected to probe sonication (Ql25, Qsonica, Newtown, CT, USA) for 20 min, resulting in a stable and well-mixed colloidal dispersion. The prepared slurry was poured into a cylindrical silicone mold (10 mm wall thickness; Dragon Skin, Smooth-On, Macungie, PA, USA) with a copper insert (plug) blocking the bottom opening of the mold. The mold was placed on top of a cold finger for unidirectional solidification. The temperature of the cold finger was set by a closed-loop thermoelectric temperature control system. It includes a digitally controlled Peltier module (Custom Thermoelectric, LLC, Bishopville, MD, USA), type-K thermocouples (Adafruit Industries, New York, USA), an Arduino board (Mega, SparkFun Electronics, Niwot, CO, USA), and a custom-made recirculating chiller. The demolded frozen samples were manually sliced into the desired geometries (such as cuboids, cubes, or discs). The morphology of the frozen slurry enabled cutting frozen samples before drying, reducing the process complexity, and preventing pore blockage. Then, samples were placed under a fume hood for 12 hours for camphene sublimation. Those green samples were then sintered in a tube furnace (Lindberg/Blue M 1200, Thermo Fisher Scientific, Waltham, MA, USA) in a nitrogen environment at 1200 °C for 3 hours to obtain the porous silica parts. The sintering profile included a heating rate of 5 °C min-¹ to 800 °C, followed by 1 °C min-¹ to 1200 °C, and a 3 hours dwell period at this temperature. The sample was then cooled down to room temperature with a maximum cooling rate of 5 °C min-¹ to prevent cracks from forming.

The pore morphology characteristics, such as the distributions of equivalent pore size, maximum Feret diameter, and pore orientation of the freeze-cast silica samples are shown in FIG. 8. Note that the cross-sectional dimensions of the rectangular prism samples used in this study are about 1 mm×about 1 mm), which are more than 20 times larger than the average pore size (about 46.3 μm) of the freeze-cast silica with 60% porosity. The analysis showed that there are more than 350 pores in each cross-section, providing a statistically significant sample size.

Preparation of MXene Dispersion: To prepare the MXene dispersion, ThC2Tx MXene flakes were synthesized using the minimally intensive layer delamination (MILD) method. Briefly, ThAlC2 MAX powder (<40 μm particle size, Carbon-Ukraine Ltd., Kyiv, Ukraine) was etched with a mixture of hydrochloric acid and lithium fluoride under continuous stirring at room temperature for 24 hours. Subsequently, the synthesized acidic ThC2Tx MXene was washed several times with deionized (DI) water to increase its pH up to 6. At each wash cycle, MXene was dispersed into the newly added DI water by shaking the container manually, and the obtained slurry was centrifuged to precipitate ThC2Tx flakes while discarding the liquid part. At the last wash cycle, about 5 mL DI water was added to the precipitated ThC2Tx to create a high-concentration mixture. The overall preparation procedure is shown in FIG. 26a. The MXene concentration of the prepared dispersion was

calculated using thermogravimetric analysis (TGA). The obtained dispersion was then diluted to the desired concentrations of 45 mg/mL, 90 mg/mL, 135 mg/mL, and 180 mg/mL by adding DI water. A synthesized MXene dispersion is shown in FIG. 1e.

Fabrication of MXene Aerogels: To obtain the MXene aerogel, the synthesized MXene dispersion was diluted to a specific concentration of 30.45 mg/mL. It is important to note that this value shows the amount of MXene (per volume) distributed in 3D space within silica backbones as a result of the infiltration approach (see FIG. 7). The aqueous dispersion with 30.45 mg/mL MXene concentration was then filled into a cylindrical silicone mold with a copper insert at the bottom, the same geometry as the MX-PS samples. To realize unidirectional freezing, the mold was placed on a cold finger placed in liquid nitrogen. The frozen sample was then kept inside a lyophilizer (Harvest Right, UT) for drying. After a 27 hour long drying cycle, the cylindrical MXene aerogel was obtained. The cuboid MXene aerogels used for electrical conductivity measurement (FIG. 13) were obtained by placing the MXene dispersion in a trench of 1 mm×1 mm×10 mm carved inside a block polydimethylsiloxane (PDMS); followed by a freezing process in liquid nitrogen and drying in the same lyophilizer.

MXene Characterization: The size (hydrodynamic diameter) distribution of as-synthesized ThC2Tx MXene nanoflakes, shown in Figure Id, was determined using the dynamic light scattering technique (Malvern Zetasizer Nano, model Zen 3600, Malvern, UK). Transmission electron microscopy (TEM) and selected-area diffraction (SAED) images were taken using an FEI Tecnai F20 microscope (Hillsboro, OR, USA) at an accelerating voltage of 200 kV. Samples were prepared by drop-casting a ThC2Tx MXene dispersion on a lacey carbon film of a 200-mesh copper grid. The TEM

image of a single ThC2Tx MXene flake is shown in FIG. 1e; and FIG. 27. Thermogravimetric
analysis (TGA Q50, TA Instruments, New Castle, DE, USA) of MXene was performed to determine the concentration of the saturated aqueous MXene dispersions by precisely measuring the change in mass as with the rising temperatures up to 300 °C under nitrogen. As shown in FIG. 1f; and FIG. 19b, the measured mass remains constant as the water evaporates during TGA. The remaining (solid) mass value at 200 °C was used as the mass of the MXene in the initial dispersion. Finally, the concentration was calculated by dividing the mass value by the initial slurry volume.

Preparation of MX-PS: The sintered porous silica samples were placed inside individual vials. MXene dispersion with a specific concentration (300-400 μL) was added to each vial to submerge the sample fully. To facilitate the infiltration process, the vials were placed in a vacuum. The vacuuming duration was selected as 10 min to avoid excessive evaporation affecting the dispersion's MXene concentration. The vials were then sealed and refrigerated for 12 hours to minimize MXene oxidation during the wetting of the backbone and accompanying MXene transport into the pores. The images of freeze-cast silica samples in a vial during the vacuum-assisted (capillary) infiltration process are given in FIG. 21. The infiltration duration of 12 hours was determined based on a preliminary study that

investigated the effect of infiltration duration on conductivity, as shown in FIG. 11d. The infiltrated samples were then placed in clean vials and dried in a vacuum chamber for 12 hours. At the end of the infiltration and drying processes, the dried MXene nanosheets were thinly coated on both the internal and external surfaces of the samples. The accumulated MXene on the external surfaces was carefully cleaned with damp foam-tipped swabs (see FIG. 22) to reduce/prevent potential blockage of the pore entrances and to reduce/eliminate the effect of this surface layer on the electrical measurements. The obtained MXene-infiltrated porous silica (MX-PS) samples were stored under a vacuum (Rocker 800, Rocker Scientific Co., Ltd, Taiwan) at 4 °C to minimize oxidation until measurements are performed.

Compression Tests: For the assessment of the compressive properties of the porous silica samples (cylindrical geometry with about 10 mm diameter and 10 mm height), a universal testing machine (5969, Instron, Norwood, MA, USA) with a 1 kN load cell was used. The effective elastic modulus of porous silica was much lower than the frame of the test apparatus. As a result, the platen displacement was taken as the displacement of the samples and used for the calculation of their engineering strain. For MXene aerogels (cylindrical geometry with about 10 mm diameter and 10 mm height), due to the weaker mechanical properties of samples, a dynamic mechanical analyzer (RSA-G2 Solids Analyzer, TA Instruments, New Castle, DE, USA) with a 50 N load cell was used to obtain their compressive behavior. Engineering stress and engineering strain responses of more than four samples were obtained for each sample type.

Electrical/Electrochemical Measurements-Four-Wire Resistance Measurements and Conductivity Calculations: Elongated cuboid samples (with about 1 mm×1 mm×10 mm dimensions, see FIGS. 24 and 25a) were used to determine electrical conductivity. Longitudinal four-wire resistance measurements were performed using an ohmmeter (34470A, Keysight, Santa Rosa, CA, USA). To minimize contact resistance, a conductive paint (PELCO Conductive Silver Paint, Ted Pella, Inc., Redding, CA, USA) was applied at the sample-wire junctions. The sample dimensions were precisely measured by a wide-area 3D measurement system (VR5200, Keyence Corporation, Osaka, Japan).

Electrical/Electrochemical Measurements-Supercapacitor Measurements: All supercapacitor measurements were performed in a symmetric two-electrode sandwich configuration (FIG. 4a; and FIG. 23), where the anode and cathode electrodes were made of disc-shaped MX-PS samples with a diameter of about 10 mm and a thickness of about 1 mm. A porous polypropylene membrane (3501, Celgard LLC, Charlotte, NC, USA) was used as the separator and 3 m poly(vinyl alcohol) (PVA)/H2SO4 was used as the electrolyte. To ensure good electrical conductivity, a thin layer of conductive silver adhesive was applied to the outer surfaces of the MX-PS electrodes as current collectors. Copper tape was attached to these current collectors, and a secondary layer of silver adhesive was thinly coated on the surface, covering the copper tape, to improve the contact region. To prevent oxidation, the copper tape was entirely sealed with Kapton tape, except for the contact region with the electrode. Finally, the prepared electrodes and the separator were sandwiched and packed together with Kapton tape.

Cyclic voltammetry (CV) and GCD tests were performed within the potential range of 0-0.5 V, which was selected to avoid parasitic reactions at low rates and oxidation of TbC2Tx MXene. EIS was performed at open circuit potential with an amplitude of 5 mV, from 10 mHz to 10 kHz. The supercapacitor capacitance (CSC) was then calculated using the cyclic voltammetry (CV) curve as

$${C}_{sc} = \frac{fI ( V ) dV}{k Δ V}$$

where I is the current (A) in the negative CV curve, k is the scan rate (V s-¹), and 11V is the operating voltage window (V). The gravimetric and areal specific capacitances of devices were determined by dividing the capacitance by the total mass or projection area of electrodes (i.e., the circular area of the overlapping electrodes), respectively.

The areal energy density (EA, mWh cm-²) and areal power density (PA, mW cm-²) of the supercapacitors were calculated using the areal capacitance of the device (CA,F cm-²), the operating voltage (V, V), and the discharge time (/1 td, s) as

$${E}_{A} = \frac{1000}{2 \times 3600} {C}_{A} {V}^{2}$$

$${P}_{A} = \frac{3600}{Δ {t}_{A}} {E}_{A}$$

Characterization of Structure and Properties: To analyze the microstructure of MX-PS samples, a straight scoring mark was made in the middle of the sample, and the sample was broken into two pieces along this mark. This approach was favored over cross-sectioning using a diamond saw to minimize the potential damage to the microstructure (e.g., deep cracks and filling of pores with sawdust). The inner surfaces (cross-sections) created through breakage exhibited some height variations, as shown in FIG. 2; and FIG. 9a. The surface microscopy images of the as-produced samples (porous silica and MX-PS electrodes) were captured and analyzed using SEM (Quanta600 FEG, FEI, Hillsboro, OR, USA) and energy-dispersive X-ray spectroscopy (EDX, Oxford Inca, Oxford Instruments, UK). Electrochemical measurements, including EIS, CV, and GCD, of the assembled supercapacitors were recorded by a potentiostat/galvanostat workstation (VersaSTAT3, Princeton Applied Research, Ametek, Inc., Berwyn, PA, USA). All experiments and electrochemical analyses of the prepared supercapacitors were performed in standard temperature and pressure (293.15 K, and 1 atm).

The present invention is directed to the following statements:
Statement 1. An internally-coated three-dimensional material comprising a porous inorganic scaffold having an internal pore system comprising internal pores and interconnected interior channels
   in open communication with an exterior surface of the porous scaffold; and a functional conformal coating comprising OD materials, ID materials, 2D materials, and any combination there of, and in contact with interior surfaces of the internal pores and the interconnected interior channels. The functional conformal coating is at least one of electrically conductive and electrochemically active. The scaffold comprises an initial open porosity with a pore diameter from up to 999 micrometers prior to coating. The functional conformal coating comprises a thickness of 1-100 nm.
Statement 2. The material of any of the foregoing statements, wherein the functional conformal coating comprises OD (nanoparticles), ID (e.g., carbon nanotubes, metal oxide nanorods) and 2D materials (e.g., MXenes, graphene), or any combination thereof.
Statement 3. The material of any of the foregoing statements, wherein the internal pore system is substantially maintained such that the coated material comprises internal pores and interconnected interior channels in open communication with an exterior surface of the coated material.
Statement 4. The material of any of the foregoing statements, wherein the coated material has an open porosity that is greater than 0, at least 5%, at least 10%, at least 15%, at least 20%, at least 25%, at least 30%, at least 35%, at least 40%, at least 45%, at least 50%, at least 75%, at least 80%, at least 90%, at least 92%, at least 95%, at least 98%, at least 99% of the initial open porosity of the scaffold prior to coating. The lower limit may be 0%, 5%, 10%, 15%, 20%, 25%, 30%, 35%, 40%,
   45%, 50%, 55%, 60%, 65%, 70%, 75%, 80%, 85%, 90%, 92%, 95%, 98%, or 99%. The upper limit
   may be 55%, 60%, 65%, 70%, 75%, 80%, 85%, 90%, 92%, 95%, 98%, or 99%.
Statement 5. The material of any of the foregoing statements, wherein the internal pores system comprises at least 90%, at least 92%, at least 95%, at least 98%, at least 99% of total surface area of the scaffold. The lower limit may be 5%, 10%, 15%, 20%, 25%, 30%, 35%, 40%, 45%, 50%,
   55%, 60%, 65%, 70%, 75%, 80%, 85%, 90%, 92%, 95%, 98%, or 99%. The upper limit may be 5%,
   10%, 15%, 20%, 25%, 30%, 35%, 40%, 45%, 50%, 55%, 60%, 65%, 70%, 75%, 80%, 85%, 90%,
   92%, 95%, 98%, or 99%.
Statement 6. The material of any of the foregoing statements, wherein the internal pore system comprises directional porosity and/or non-directional (arbitrary) porosity.
Statement 7. The material of any of the foregoing statements, wherein the internal pore system comprises an open pore network of nanoporous (pore size<2 nm) materials, mesoporous (pore size 2-50 nm) materials, macroporous (pore size>50 nm) materials, or any combination thereof.
Statement 8. The material of any of the foregoing statements, wherein the initial open porosity prior to coating is an open pore network of mesopores, an open pore network of macropores, or an open pore network with a combination of mesopores and macropores.
Statement 9. The material of any of the foregoing statements, wherein the initial open porosity prior to coating is an open pore network with a mean pore diameter from at least 5 μm to greater than 500 μm. The lower limit may be 1, 5, 10, 15, 20, 25, 30, 35, 40, 45, 50, 55, 60, 65, 70, 75, 80, 85, 90,
   95, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, or 975 micrometers.
   The upper limit may be 5, 10, 15, 20, 25, 30, 35, 40, 45, 50, 55, 60, 65, 70, 75, 80, 85, 90, 95, 100,
   125, 150, 175, 200, 225, 250, 275, 300, 325, 350, 375, 400, 425, 450, 475, 500, 525, 550, 575, 600,
   625, 650, 675, 700, 725, 750, 775, 800, 825, 850, 875, 900, 925, 950, 975, or 1000 micrometers.
Statement 10. The material of any of the foregoing statements, wherein the internal pore system comprise 10-100 μm average pore size. The lower limit may be 1, 5, 10, 15, 20, 25, 30, 35, 40,
   45, 50, 55, 60, 65, 70, 75, 80, 85, 90, 95, or 100 micrometers. The upper limit may be 5, 10, 15, 20,
   25, 30, 35, 40, 45, 50, 55, 60, 65, 70, 75, 80, 85, 90, 95, or 100 micrometers.
Statement 11. The material of any of the foregoing statements, wherein the nanomaterial deposit on the inner surfaces of the interconnected pores as a thin-layer of conformal coating. Statement 12. The material of any of the foregoing statements, wherein the coating is an interconnected three-dimensional MXene network.
Statement 13. The material of any of the foregoing statements, wherein the coating comprises MXenes (e.g., transition metal carbides, nitrides, and carbonitrides) nanoflake having 1-5 μm size, 0.5-2 nm thickness, and 3.7 g cm-³ density).
Statement 14. The material of any of the foregoing statements, wherein the conformal coating comprises a plurality of layers separated by nanoparticles (OD), nanofibers (1D), or 2D nanoflakes as physical separators. 2D nanomaterials, 1D nanomaterials, and nanoparticles, or a combination of these.
Statement 15. The material of any of the foregoing statements, wherein the coating comprises a functional group on its surface (such as —F, —OH, —O, and —Cl) that is chemically active for use in surface reactions.
Statement 16. The material of any of the foregoing statements, wherein the coating comprises transition metal carbides, nitrides, or carbonitrides selected from the MXene groups having single metal element structures (i.e., Ti3C2Tx, Ti2CTx, V2CTx, etc.), ordered double transition metal MXenes (i.e., Mo2Ti2C3Tx, Mo2TiC2Tx, Cr2TiC2Tx, etc.), solid solution MXenes (i.e., Ti2-yVyCTx, Mo4-yVyC3Tx, Ti2-yNbyCTx), and ordered divacancy MXenes (Mol.33CTx, W1.33CTx, etc.), and any combination thereof.
Statement 17. The material of any of the foregoing statements, wherein the MXene (transition metal carbides, nitrides and carbonitrides) comprises two-dimensional Ti3C2Tx MXene nanoflakes, wherein the single-layer material comprises a lateral flake size ranging from O.1-40 μm, a flake thickness size ranging from 0.5-3 nm, a density of 2-4.5 g cm-³, and >1000:1 flake aspect ratio. Statement 18. The material of any of the foregoing statements, wherein the nanomaterial is graphene, or carbon nanotubes, or ceramic or metal nanoparticles, or their combination.
Statement 19. The material of any of the foregoing statements, wherein the coating on the walls of the internal pores and the interconnected interior channels is 1-50 nm thick, 5-500 nm thick,
   5-100 nm thick, or 10-300 nm thick. The lower limit may be 1, 5, 10, 15, 20, 25, 30, 35, 40, 45, 50,
   55, 60, 65, 70, 75, 80, 85, 90, 95, 100, 125, 150, 175, 200, 225, 250, or 275 nanometers. The upper
   limit may be 5, 10, 15, 20, 25, 30, 35, 40, 45, 50, 55, 60, 65, 70, 75, 80, 85, 90, 95, 100, 125, 150,
   175, 200, 225, 250, 275, or 300 nanometers.
Statement 20. The material of any of the foregoing statements, wherein the porous scaffold has a wall thickness, separating pores, of less than 1 micrometer up to 1000 micrometers. The lower limit maybe 1, 5, 10, 15, 20, 25, 30, 35, 40, 45, 50, 55, 60, 65, 70, 75, 80, 85, 90, 95, 100, 125, 150, 175,
   200, 225, 250, 275, 300, 325, 350, 375, 400, 425, 450, 475, 500, 525, 550, 575, 600, 625, 650, 675,
   700, 725, 750, 775, 800, 825, 850, 875, 900, 925, 950, or 975 micrometers. The upper limit may be 5,
   10, 15, 20, 25, 30, 35, 40, 45, 50, 55, 60, 65, 70, 75, 80, 85, 90, 95,
   100, 125, 150, 175, 200, 225, 250,
   275, 300, 325, 350, 375, 400, 425, 450, 475, 500, 525, 550, 575, 600, 625, 650, 675, 700, 725, 750, 775, 800, 825, 850, 875, 900, 925, 950, 975, or 1000 micrometers.
Statement 21. The material of any of the foregoing statements, wherein the porous substrate has pores with a pore size distribution that is multimodal, and the pore diameter distribution covers a range from less than 1 nm to 500 μm.
Statement 22. The material of any of the foregoing statements, wherein the substrate has a void volume of 0.5 mm³ cm³/g to 2 mm³ cm³/g as determined by mercury intrusion porosimetry.
Statement 23. The material of any of the foregoing statements, wherein the internal pore system is created using a camphene-based material system, wherein the internal pore system comprises dendritic and hierarchical pores comprising a network of internal pores having branching (i.e., large directional channels) that has lateral pores caused by side branches with smaller diameters (branches of tree), creating hierarchical porosity (large, medium, and small pores within the same sample). The material comprises an average pore size of up to 999 μm. The lower limit may be 1, 5, 10, 15, 20, 25, 30, 35, 40, 45, 50, 55, 60, 65, 70, 75, 80, 85, 90, 95, 100, 125, 150, 175, 200, 225, 250,
   275, 300, 325, 350, 375, 400, 425, 450, 475, 500, 525, 550, 575, 600, 625, 650, 675, 700, 725, 750,
   775, 800, 825, 850, 875, 900, 925, 950, or 975 micrometers. The upper limit may be 5, 10, 15, 20, 25,
   30, 35, 40, 45, 50, 55, 60, 65, 70, 75, 80, 85, 90,
   95, 100, 125, 150, 175, 200, 225, 250, 275, 300, 325,
   350, 375, 400, 425, 450, 475, 500, 525, 550, 575, 600, 625, 650, 675, 700, 725, 750, 775, 800, 825,
   850, 875, 900, 925, 950, 975, or 1000 micrometers. The material comprises a major pore elongation creating channels with an aspect ratio of at least 50, at least 60, at least 70, at least 75, at least 80, at least 85, at least 90, at least 92, at least 95, at least 98, or at least 99. The material comprises arbitrary side branching connecting major pore channels. The material comprises a major pore orientation defined by pore elongation along a specific direction.
Statement 24. The material of any of the foregoing statements, wherein the interconnected interior channels are partially or completely coated with a OD, 1D, or 2D material (e.g., MXenes, including transition metal carbides, nitrides and carbonitrides) layer.
Statement 25. The material of any of the foregoing statements, wherein the functional conformal coating enables electrical conductivity and electrochemical activity, which may be directional dictated by the pore characteristics and orientation of the substrate/backbone. When the backbone has directional porosity, which indicates the internal channels are oriented mainly along a specific direction with side branches perpendicular to these channels actualizing pore connectivity, then the coated backbone comprises a directional electrical conductivity and electrochemical activity, which means the material comprises higher electrical conductivity along a specific direction.
Statement 26. The material of any of the foregoing statements, wherein the ID or 2D functional conformal coating (in one embodiment, the 2D coating is MXene) is maintained as an electrically conductive network characterized by geometrical dimensions (height, width, depth) and electrical conductivity.
Statement 27. The material of any of the foregoing statements, wherein the ID or 2D functional conformal coating (in one embodiment, the 2D coating is MXene) is maintained as an electrochemically active network characterized by impedance, which is the opposition to alternating current presented by the combined effect of resistance and reactance in a circuit, and capacitance, which is the capability of a material object or device to store electric charge.
Statement 28. The material of any of the foregoing statements, wherein the electrochemically active OD, ID or 2D coated (in one embodiment, the 2D coating is MXene) backbone may demonstrate directionally improved electrochemical performance, where the impedance can be lower along the main pore orientation compared to perpendicular directions.
Statement 29. The material of any of the foregoing statements, wherein the electrochemically active MXene coated backbone may demonstrate directionally improved electrochemical performance, where the capacitance can be higher along the main pore orientation compared to perpendicular directions.
Statement 30. The material of any of the foregoing statements, wherein the functional conformal coating may comprise a plurality of sub-layers.
Statement 31. The material of any of the foregoing statements, wherein the coating is at least as thick as a single layer of Ti3C2Tx MXene (e.g., 1-3 nm thick), if Ti3C2Tx MXene is used as the coating material.
Statement 32. The material of any of the foregoing statements, wherein the coating is at least as thick as a single layer of graphene, carbon nano tubes, nanoparticles, graphene oxide, or other OD, ID, and 2D materials, and combinations thereof.
Statement 33. The material of any of the foregoing statements, the porous substrate comprises: ceramics (e.g., silica, alumina, zirconia, etc.), metals (e.g., nickel, aluminum, titanium, silver, etc.), polymers (e.g., polystyrene, polyethylene, polypropylene, etc.), and carbonaceous materials (e.g., carbon black, carbon nano tube, carbon nano ribbon, graphene, graphite, etc.).
Statement 34. The material of any of the foregoing statements, wherein the functional conformal coating is composed of OD (e.g., nanoparticles), ID (e.g., carbon nanotubes, metal oxide nanorods) and 2D materials (e.g., MXenes, graphene).
Statement 35. The material of any of the foregoing statements, wherein the coating comprises a plurality of layers, optionally separated by nanoparticles (OD), nanofibers (ID), or 2D nanoflakes as physical separators. The coating may comprise one or more polymers, e.g., elastomers, resins.
Statement 36. An electrode component comprising the coated material of any of the foregoing statements.
Statement 37. The component of any of the foregoing statements, wherein the electrical conductivity along the main pore orientation of the backbone is at least three times higher than that for minor pore orientations.
Statement 38. The component of any of the foregoing statements, wherein the electrode having a longitudinal porosity (i.e., pores mainly oriented toward the counter electrode) has three times higher capacitance than an electrode having a lateral porosity (i.e., pores mainly oriented parallel to the counter electrode).
Statement 39. A slurry to form the coated material of any of the foregoing statements, the slurry comprising solid nanopowder and/or solid micro powder; a dispersant (e.g., Croda Hypermer KD-24, Croda Hypermer KD-23, Croda Hypermer KD-4) (R. T. Vanderbilt Co. Darvan C, etc.); and a solvent (e.g., water, camphene, glycerine, tert-butyl alcohol, cyclohexane, cyclooctane, and mixtures thereof).
Statement 40. The slurry of any of the foregoing statements, wherein the material comprises a ceramic, such as silica having an average particle size of 400 nm, alumina having an average particle size of 600 nm, silicon carbide, zirconia, etc.
Statement 41. The slurry of any of the foregoing statements, wherein the material comprises a metal such as nickel, stainless steel, aluminum, copper, other metals and their alloys.
Statement 42. The slurry of any of the foregoing statements, wherein the slurry comprises microstructures or nanostructures in the form of amorphous, near-spherical, spherical, disk-shaped geometries.
Statement 43. The slurry of any of the foregoing statements, wherein an average length of the microstructures and/or nanostructures is at least twice an average thickness of the microstructures or nanostructures.
Statement 44. The slurry of any of the foregoing statements wherein a pH is 5-7.5.
Statement 45. The slurry of any of the foregoing statements comprising a weight ratio of the dispersant to the ceramic powder is 0.01-3%; and a volume ratio of the powder to the total volume of the slurry (also known as the initial solid loading) is 10-90%.
Statement 46. A method of fabricating a composite material system comprising the material of any of the foregoing statements, the method comprising: directional freezing a powder slurry to yield a phase-segregated frozen solvent green body; drying the frozen powder slurry to sublimate the frozen solvent to yield a freeze-dried porous material (also known as green body in materials science field); sintering the freeze-dried green body to yield a mechanically robust porous backbone/substrate defining a multiplicity of pores; and infiltrating pores of the backbone with a 0D/1D/2D coating material (e.g., MXene) by submerging at least a portion of it in an liquid dispersion of the coating material (e.g., single or multiplayer MXene nanosheets); and applying vacuum for 10-15 minutes to reduce/remove the entrapped air from the porous backbone; and keeping the backbone submerged inside the dispersion for a time sufficient (e.g., 10 minutes to 24 hours) to wet and cover all or at least a portion of the interior pore surfaces; and drying the wetted porous backbone after removing it from the dispersion to a clean vial to dry for 12 hours under vacuum or placing the wetted substrate inside a freeze-dryer to remove water content, thereby yielding the composite material of 0D/1D/2D material infiltrated porous substrate.
Statement 47. The method of any of the foregoing statements comprising adjusting the initial solid loading, particle size of solid component of slurry, solvent type, cooling temperature or rate, cooling direction (unidirectional, or multi-directional), annealing temperature and duration (applicable to frozen slurry, enables further pore growth by keeping frozen sample at an elevated temperature, which is lower than the melting point of the solvent) of the freeze-cast slurry before sintering to control a density, size, orientation (direction), and shape of the pores.
Statement 48. The method of any of the foregoing statements, wherein the sintering, which is the process of compacting and forming a solid mass of material by pressure or heat without melting it to the point of liquefaction, occurs at a temperature smaller than the melting temperature of the ceramic powder.
Statement 49. A method of making a composite material system comprising the material of any of the foregoing statements, the method comprising: introducing a dispersion comprising two-dimensional nanoflakes (e.g., MXene, including transition metal carbide, nitrides and carbonitrides) into a substrate having open porosity; and applying vacuum for a time sufficient (e.g., 10-15 minutes) to reduce/remove the entrapped air from the porous backbone; and submerging at least a portion of the substrate in the dispersion for a time sufficient (10 minutes to 24 hours) to wet and cover all or at least a portion of the interior pore surfaces; removing the wetted porous substrate from the dispersion, and drying the wetted porous substrate in clean vial under vacuum or in a freeze-dryer for a time sufficient (10 minutes to 24 hours) to reduce/remove water content, thereby yielding the composite material of 0D/1D/2D material infiltrated porous substrate.
Statement 50. The method of any of the foregoing statements, wherein introducing the 2D material (e.g., MXene) dispersion into the void of substrate comprises positioning the porous substrate in the dispersion.
Statement 51. The method of any of the foregoing statements, wherein introducing the 2D material (e.g., MXene) dispersion into the void of substrate comprises flowing the dispersion through one or more microchannels within the substrate to fill the pores and cover all the pore surfaces inside the substrate.
Statement 52. A method of manufacturing a composite material system comprising a 3D arrangement of 0D/1D/2D material network of any of the foregoing statements, the method comprising: fabricating porous backbones (e.g., ceramic, metal, polymer) having controlled porosity using the freeze casting process; and synthesizing 0D/1D/2D material and preparing the dispersion having a desired 0D/1D/2D material concentration and nanoflake size and thickness; and infiltrating pores of backbone with 0D/1D/2D material by submerging it in an aqueous dispersion of 0D/1D/2D material, single or multiplayer MXene nanosheets); and applying vacuum for 10-15 minutes to remove/reduce the entrapped air from the porous backbone; and submerging all or at least a portion of the backbone in the 0D/1D/2D material dispersion for a time sufficient (e.g., 10 minutes to 24 hours) to wet and cover all or at least a portion of the interior pore surfaces of the backbone; and removing the wetted porous backbone from the 0D/1D/2D material (e.g., MXene) dispersion, and drying the wetted porous backbone in clean vial under vacuum or in a freeze-dryer for a time sufficient (10 minutes to 24 hours) to reduce/remove water content, thereby yielding the composite material of 0D/1D/2D material infiltrated porous substrate, wherein the network's spatial distribution is tuned by the freeze casting parameters, which are the initial solid loading, particle size of solid component of slurry, solvent type, cooling temperature or rate, cooling direction (unidirectional, or multi-directional), annealing temperature and duration (which is applicable to frozen slurry before drying and enables further pore growth by keeping frozen sample at an elevated temperature, which is lower than the melting point of the solvent), sintering temperature and duration.
Statement 53. The method of any of the foregoing statements, wherein adjusting the 0D/1D/2D material (e.g., MXene) MXene infiltration comprises controlling concentration of 0D/1D/2D material (e.g., MXene) MXene dispersion, controlling infiltration duration during which the porous silica substrate is held submerged within 0D/1D/2D material (e.g., MXene) MXene dispersion, number of infiltration cycles that is single infiltration or multiple infiltration processes (which imply infiltration of a sample that was already infiltrated and dried prior to next infiltration step; also the 0D/1D/2D material (e.g., MXene) MXene concentration per infiltration cycle is independently controlled.
Example 1: 1st cycle with 180 mg/mL MXene, 2nd cycle with 90 mg/mL MXene, 3rd cycle 45 mg/mL MXene; Example 2: 1st cycle with 180 mg/mL MXene, 2nd cycle with 180 mg/mL MXene, 3rd cycle 180 mg/mL MXene, 4th cycle 180 mg/mL, etc.).
Statement 54. The method of any of the foregoing statements, wherein the 0D/1D/2D material (e.g., MXene) MXene infiltrates the porous silica backbone at least to a depth of 5 mm, ensuring coverage of the internal pores that are 5 mm deep inside from the external surface of the backbone. Statement 55. The method of any of the foregoing statements, wherein the infiltrating comprises single infiltration, meaning the porous backbone is submerged into a 0D/1D/2D material (e.g., MXene) dispersion with controlled concentration only once and dried afterwards to obtain the composite material system.
Statement 56. The method of any of the foregoing statements, wherein the infiltrating comprises multiple infiltration cycles, indicating infiltration of a porous sample that was already infiltrated and dried prior to next infiltration step by repeating the following steps: infiltrating pores of the backbone with 0D/1D/2D material (e.g., MXene) by submerging it in an aqueous dispersion of 0D/1D/2D material (e.g., MXene, single or multiplayer MXene nanosheets); and applying vacuum for a time sufficient (10-15 minutes) to reduce/remove the entrapped air from the porous backbone; and submerging all or at least a portion of the backbone in the 0D/1D/2D material (e.g., MXene) dispersion for a time sufficient (e.g., 10 minutes to 24 hours) to wet and cover all or at least a portion of the pore surfaces of the backbone; removing the wetted porous backbone from the 0D/1D/2D material (e.g., MXene) dispersion; and drying the wetted porous backbone in clean vial under vacuum or the wetted silica substrate in a freeze-dryer for a time sufficient (10 minutes to 24 hours) to reduce/remove water content, thereby yielding the composite material of 0D/1D/2D material (e.g., MXene) infiltrated porous substrate.
Statement 57. The method of any of the foregoing statements, wherein the 0D/1D/2D material (e.g., MXene) MXene concentration is up to 180 mg/mL (4 vol. % solid loading).
Statement 58. The method of any of the foregoing statements, wherein the MXene viscosity is 0.350 Pas.
Statement 59. The method of any of the foregoing statements, wherein the electrical conductivity of the composite material system consisting of a 3D MXene network on its internal channels is up to 340 S/m.
Statement 60. The method of any of the foregoing statements, wherein the network has anisotropy (the quality of exhibiting properties with different values when measured along axes in different directions) of electrical conductivity because the 0D/1D/2D material (e.g., MXene) infiltrated backbone possesses a directional porosity due to unidirectional freeze casting, which indicates the slurry was frozen along a specific direction and since the internal pores and channels originate from the frozen crystals of the solvent (camphene for this case), the freeze casting yields an anisotropic pore morphology.
Statement 61. A method of manufacturing a composite material system comprising a connected 3D network of 0D/1D/2D material of any of the foregoing statements (e.g., MXene), the method comprising: freeze casting of a powdered solid to yield a porous backbone/substrate having open hierarchical porosity and a controlled porosity and pore size distribution; submerging the porous structure in a dispersion of 0D/1D/2D material (e.g., MXene, single or multiplayer MXene nanosheets) to infiltrate 0D/1D/2D material (e.g., MXene) into pores of the structure to establish the 3D network of 0D/1D/2D material (e.g., MXene) comprising nanoflakes on the internal pore surfaces of porous silica; and removing the wetted porous backbone from the 0D/1D/2D material (e.g., MXene) dispersion, and drying the wetted porous backbone in clean vial under vacuum or a time sufficient (10 minutes to 24 hours) to reduce/remove water content or in a freeze-dryer for a time sufficient to reduce/remove water content, thereby yielding the composite material of 0D/1D/2D material (e.g., MXene) infiltrated porous material system (e.g., MX-PS) system; and storing the material (e.g., in a refrigerator) at 4 °C or lower temperatures in sealed vials until use to minimize oxidation; wherein the 0D/1D/2D material (e.g., MXene)-to-backbone mass ratio is in the range from greater than 0 up to 10% for single infiltration cycles. The method may comprise repeating the coating step via multiple infiltration cycles (e.g., this ratio may be 25% for a MX-PS sample that is infiltrated with 180 mg/mL MXene concentration by three times).
Statement 62. The method of any of the foregoing statements, wherein the 0D/1D/2D material comprises a MXene, e.g., Ti3C2Tx.
Statement 63. The method of any of the foregoing statements, wherein the 0D/1D/2D material (e.g., MXene) dispersion comprises an exfoliated single-layer and a delaminated multilayer of Ti3C2Tx MXene flakes.
Statement 64. The method of any of the foregoing statements, wherein ceramic freeze casting comprises unidirectional freeze casting using a camphene-based solvent to yield the dendritic and hierarchical porosity within the silica structure.
Statement 65. The method of any of the foregoing statements, wherein the dispersion of MXene is infiltrated into the porous silica using capillary flow.
Statement 66. The method of any of the foregoing statements, wherein the 2D MXene flakes conformally coat interior surfaces of an interconnected micropore network within the silica structure without blocking pore access.
Statement 67. The method of any of the foregoing statements, wherein the MXene nanoflakes adhere to both interior surfaces of the silica structure and other MXene nanoflakes.
Statement 68. The material of any of the foregoing statements, wherein the morphology and properties of the internal pore system is related the liquid media or solvent, including but not limited to water, camphene, tert-butyl alcohol, cyclooctane, cyclohexane, dioxane, and dimethyl carbonate.
Statement 69. The material of any of the foregoing statements, wherein the final pore morphology of freeze-cast materials is predicted by dimensionless Jackson alpha-factor, which is determined, inter alia, by the melting point and enthalpy of fusion of the solvent, and describes the
   crystal growth regime responsible for morphology of solvent crystals formed during solidification. Solvents having low Jackson alpha-factor, such as acetone, benzene, etc., may create non-faceted, irregularly shaped pore morphologies with rough surfaces. Solvents having intermediate Jackson alpha-factor, such as camphene, chloroform, diethyl ether, etc., may create dendritic pore morphologies. Solvent having high Jackson alpha-factor, such as water, methanol, acetonitrile, etc., may create faceted and sometimes lamellar pore morphologies with regular shapes and smooth surfaces.
Statement 70. The material of any of the foregoing statements, wherein the porous substrate is fabricated via suspension-based freeze casting of polymers, wherein the solid component of the initial slurry is not soluble in the selected liquid component, such as polyether ether ketone (PEEK) and camphene, or polytetrafluoroethylene (PTFE) and camphene, or polyethylene (PE) and water, or polypropylene (PP) and water, etc.; wherein the initial solid particles are suspended within the liquid media with appropriate surfactants that help with particle dispersion by prevent aggregation and/or precipitation; wherein the steps of freeze casting, i.e., slurry preparation, solidification, freeze drying/sublimation, sintering, are performed similarly to those used in the freeze casting of ceramics or metals; and wherein the sintering, i.e., the last step of freeze casting, is required to mechanically strengthen the final structure.
Statement 71. The material of any of the foregoing statements, wherein the porous substrate is fabricated via solution-based freeze casting of polymers, wherein the solid component of initial slurry is soluble in the selected solvent, such as polystyrene (PS) and camphene, polyvinyl Chloride (PVC) and camphene, or polyethylene glycol and water, or polyvinyl alcohol and water, etc.; wherein the first steps of freeze casting, i.e., slurry preparation, is slightly modified, such that a solution is prepared instead of a slurry; wherein the intermediate steps of freeze casting, i.e., solidification, freeze drying/sublimation, are performed similarly to those used in the freeze casting of ceramics or metals; wherein the final porous polymer substrate is obtained after freeze drying; and wherein the sintering, i.e., the last step of freeze casting, may not be mandatory but may be applied to provide additional mechanical strength to the final porous polymer structure.

All documents cited herein are incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to this application.

While particular embodiments have been illustrated and described, it would be obvious to those skilled in the art that various other changes and modifications may be made without departing from the spirit and scope of the invention. Those skilled in the art will recognize or be able to

ascertain using no more than routine experimentation, numerous equivalents to the specific apparatuses and methods described herein, including alternatives, variants, additions, deletions, modifications and substitutions. This application including the appended claims is therefore intended to cover all such changes and modifications that are within the scope of this application.

What is claimed is:

1. An internally-coated three-dimensional material comprising:
a porous inorganic scaffold having an internal pore system comprising internal pores and interconnected interior channels in open communication with an exterior surface of the porous scaffold; and
a functional conformal coating comprising OD materials, 1D materials, 2D materials, and any combination there of, and in contact with interior surfaces of the internal pores and the interconnected interior channels,
wherein the functional conformal coating is at least one of electrically conductive and electrochemically active;
wherein the scaffold comprises an initial open porosity with a pore diameter from up to 999 micrometers prior to coating; and
wherein the functional conformal coating comprises a thickness of 1-100 nm.

2. The material of claim 1, wherein the functional conformal coating comprises OD materials comprising nanoparticles, ID materials comprising carbon nanotubes or metal oxide nanorods, and 2D materials comprising MXenes or graphene, or any combination thereof.

3. The material of claim 1, wherein the internal pore system is substantially maintained such that the coated material comprises internal pores and interconnected interior channels in open communication with an exterior surface of the coated material.

4. The material of claim 1, wherein the coated material has an open porosity that is:
greater than 0, at least 5%, at least 10%, at least 15%, at least 20%, at least 25%, at least 30%,
at least 35%, at least 40%, at least 45%, at least 50%, at least 75%, at least 80%, at least 90%, at least 92%, at least 95%, at least 98%, at least 99% of the initial open porosity of the scaffold prior to coating;
a lower limit from 0%, 5%, 10%, 15%, 20%, 25%, 30%, 35%, 40%, 45%, 50%, 55%, 60%,
65%, 70%, 75%, 80%, 85%, 90%, 92%, 95%, 98%, or 99%; or
an upper limit of 55%, 60%, 65%, 70%, 75%, 80%, 85%, 90%, 92%, 95%, 98%, or 99%.

5. The material of claim 1, wherein the internal pores system comprises:
at least 90%, at least 92%, at least 95%, at least 98%, at least 99% of total surface area of the scaffold;
a lower limit of 5%, 10%, 15%, 20%, 25%, 30%, 35%, 40%, 45%, 50%, 55%, 60%, 65%, 70%, 75%, 80%, 85%, 90%, 92%, 95%, 98%, or 99%; or
an upper limit of 5%, 10%, 15%, 20%, 25%, 30%, 35%, 40%, 45%, 50%, 55%, 60%, 65%,
70%, 75%, 80%, 85%, 90%, 92%, 95%, 98%, or 99%.

6. The material of claim 1, wherein the internal pore system comprises directional porosity and/or non-directional (arbitrary) porosity.

7. The material of claim 1, wherein the internal pore system comprises an open pore network of nanoporous (pore size<2 nm) materials, mesoporous (pore size 2-50 nm) materials, macroporous (pore size>50 nm) materials, or any combination thereof.

8. The material of claim 1, wherein the initial open porosity prior to coating is an open pore network of mesopores, an open pore network of macropores, or an open pore network with a combination of mesopores and macropores.

9. The material of claim 1, wherein the initial open porosity prior to coating is an open pore network with a mean pore diameter:
from at least 5 μm to greater than 500 μm;
a lower limit of 1, 5, 10, 15, 20, 25, 30, 35, 40, 45, 50, 55, 60, 65, 70, 75, 80, 85, 90, 95,
100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, or 975 micrometers; or
an upper limit of 5, 10, 15, 20, 25, 30, 35, 40, 45, 50, 55, 60, 65, 70, 75, 80, 85, 90, 95, 100,
125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, or 1000 micrometers.

10. The material of claim 1, wherein the internal pore system
comprise 10-100 μm average pore size;
a lower limit of 1, 5, 10, 15, 20, 25, 30, 35, 40, 45, 50, 55, 60, 65, 70, 75, 80, 85, 90, 95, or
100 micrometers average pore size; or
an upper limit of 5, 10, 15, 20, 25, 30, 35, 40, 45, 50, 55, 60, 65, 70, 75, 80, 85, 90, 95, or
100 micrometers average pore size.

11. The material of claim 1, wherein the nanomaterial deposit on the inner surfaces of the interconnected pores as a thin-layer of conformal coating.

12. The material of claim 1, wherein the coating is an interconnected three-dimensional MXene network.

13. The material of claim 1, wherein the coating comprises MXenes comprising transition metal carbides, nitrides, and carbonitrides nanoflake having 1-5 μm size, 0.5-2 nm thickness, and 3.7 g cm-³ density.

14. The material of claim 1, wherein the conformal coating comprises a plurality of layers separated by nanoparticles (OD), nanofibers (1D), or 2D nanoflakes physical separators including 2D nanomaterials, 1D nanomaterials, and nanoparticles, or any combination thereof.

15. The material of claim 1, wherein the coating comprises a functional group on its surface (including —F, —OH, —O, and —Cl) that is chemically active for use in surface reactions.

16. The material of claim 1, wherein the coating comprises transition metal carbides, nitrides, or carbonitrides selected from the MXene groups having single metal element structures (including Ti3C2Tx, Ti2CTx, V2CTx), ordered double transition metal MXenes (including Mo2Ti2C3Tx, Mo2TiC2Tx, Cr2TiC2Tx), solid solution MXenes (including Ti2-yVyCTx, Mo4-yVyC3Tx, Ti2-yNbyCTx), and ordered divacancy MXenes (including Mol.33CTx, Wl.33CTx), and any combination thereof.

17. The material of claim 1, wherein the MXene (including transition metal carbides, nitrides and carbonitrides) comprises two-dimensional Ti3C2Tx MXene nanoflakes, wherein the single-layer material comprises a lateral flake size ranging from O.1-40 μm, a flake thickness size ranging from 0.5-3 nm, a density of 2-4.5 g cm-³, and >1000:1 flake aspect ratio.

18. The material of claim 1, wherein the nanomaterial comprises graphene, or carbon nanotubes, or ceramic or metal nanoparticles, or any combination thereof.

19. The material of claim 1, wherein the coating on the walls of the internal pores and the interconnected interior channels comprise:
1-50 nm thick, 5-500 nm thick, 5-100 nm thick, or 10-300 nm thick;
a lower limit of 1, 5, 10, 15, 20, 25, 30, 35, 40, 45, 50, 55, 60, 65, 70, 75, 80, 85, 90, 95,
100, 125, 150, 175, 200, 225, 250, or 275 nanometers; or
an upper limit of 5, 10, 15, 20, 25, 30, 35, 40, 45, 50, 55, 60, 65, 70, 75, 80, 85, 90, 95, 100,
125, 150, 175, 200, 225, 250, 275, or 300 nanometers.

20. The material of claim 1, wherein the porous scaffold has a wall thickness, separating
pores, of less than 1 micrometer up to 1000 micrometers;
a lower limit of 1, 5, 10, 15, 20, 25, 30, 35, 40, 45, 50, 55, 60, 65, 70, 75, 80, 85, 90, 95,
100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, or 975 micrometers; or
an upper limit of 5, 10, 15, 20, 25, 30, 35, 40, 45, 50, 55, 60, 65, 70, 75, 80, 85, 90, 95, 100,
125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, or 1000 micrometers.

21. The material of claim 1, wherein the porous substrate has pores with a pore size distribution that is multimodal, and the pore diameter distribution covers a range from less than 1 nm to 500 μm.

22. The material of claim 1, wherein the substrate has a void volume of 0.5 mm³ cm³/g to 2 mm³ cm³/g as determined by mercury intrusion porosimetry.

23. The material of claim 1, wherein the internal pore system is manufacturing using a camphene-based material system, wherein the internal pore system comprises dendritic and hierarchical pores comprising a network of internal pores having branching (including large directional channels) that has lateral pores caused by side branches with smaller diameters (branches of tree), creating hierarchical porosity (large, medium, and small pores within the same sample), wherein the material comprises an average pore size of up to 999 μm, a lower limit of 1, 5, 10, 15, 20, 25, 30, 35, 40, 45, 50, 55, 60, 65, 70, 75, 80, 85,
90, 95, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, or 975 micrometers; and/or an upper limit of 5, 10, 15, 20, 25, 30, 35, 40, 45, 50, 55, 60, 65, 70, 75, 80, 85, 90, 95, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, or 1000 micrometers; wherein the material comprises a major pore elongation creating channels with an aspect ratio of at least 50, at least 60, at least 70, at least 75, at least 80, at least 85, at least 90, at least 92, at least 95, at least 98, or at least 99; wherein the material comprises arbitrary side branching connecting major pore channels; and wherein the material comprises a major pore orientation defined by pore elongation along a specific direction.

24. The material of claim 1, wherein the interconnected interior channels are partially or completely coated with a OD, ID, or 2D material (including MXenes, including transition metal carbides, nitrides and carbonitrides) layer.

25. The material of claim 1, wherein the functional conformal coating enables electrical conductivity and electrochemical activity, which may be directional dictated by the pore characteristics and orientation of the substrate/backbone; wherein when the backbone has directional porosity, which indicates the internal channels are oriented mainly along a specific direction with side branches perpendicular to these channels actualizing pore connectivity, then the coated backbone comprises a directional electrical conductivity and electrochemical activity, which means the material comprises higher electrical conductivity along a specific direction.

26. The material of claim 1, wherein the ID or 2D functional conformal coating is maintained as an electrically conductive network characterized by geometrical dimensions (including height, width, depth) and electrical conductivity.

27. The material of claim 1, wherein the ID or 2D functional conformal coating is maintained as an electrochemically active network characterized by impedance, which is the opposition to alternating current presented by the combined effect of resistance and reactance in a circuit, and capacitance, which is the capability of a material object or device to store electric charge.

28. The material of claim 1, wherein the electrochemically active OD, ID or 2D coated backbone may demonstrate directionally improved electrochemical performance, where the impedance is lower along the main pore orientation compared to perpendicular directions.

29. The material of claim 1, wherein the electrochemically active MXene coated backbone comprises directionally improved electrochemical performance, where the capacitance is higher along the main pore orientation compared to perpendicular directions.

30. The material of claim 1, wherein the functional conformal coating comprises a plurality of sub-layers.

31. The material of claim 1, wherein the coating is at least as thick as a single layer of Ti3C2Tx MXene when Ti3C2Tx MXene is used as the coating material.

32. The material of claim 1, wherein the coating is at least as thick as a single layer of graphene, carbon nano tubes, nanoparticles, graphene oxide, or other OD, ID, and 2D materials, and combinations thereof.

33. The material of claim 1, the porous substrate comprises: ceramics (including silica, alumina, zirconia), metals (including nickel, aluminum, titanium, silver), polymers (including polystyrene, polyethylene, polypropylene), and carbonaceous materials (including carbon black, carbon nano tube, carbon nano ribbon, graphene, graphite).

34. The material of claim 1, wherein the functional conformal coating is composed of OD materials (including nanoparticles), ID materials (including carbon nanotubes, metal oxide nanorods) and 2D materials (including MXenes, graphene).

35. The material of claim 1, wherein the coating comprises a plurality of layers, optionally separated by nanoparticles (OD), nanofibers (ID), or 2D nanoflakes as physical separators; wherein the coating comprises one or more polymers, including, elastomers, resins.

36. An electrode component comprising the coated material of claim 1.

37. The component of claim 36, wherein the electrical conductivity along the main pore orientation of the backbone is at least three times higher than that for minor pore orientations.

38. The component of claim 36, wherein the electrode having a longitudinal porosity (pores mainly oriented toward the counter electrode) has three times higher capacitance than an electrode having a lateral porosity (pores mainly oriented parallel to the counter electrode).

39. A slurry to form the coated material of any of the foregoing claims, the slurry
comprising solid nanopowder and/or solid micro powder;
dispersant; and
a solvent (including water, camphene, glycerine, tert-butyl alcohol, cyclohexane, cyclooctane, and mixtures thereof).

40. The slurry of claim 39, wherein the material comprises a ceramic, such as silica having an average particle size of 400 nm, alumina having an average particle size of 600 nm, silicon carbide, zirconia, etc.

41. The slurry of claim 39, wherein the material comprises a metal such as nickel, stainless steel, aluminum, copper, other metals and their alloys.

42. The slurry of claim 39, wherein the slurry comprises microstructures or nanostructures in the form of amorphous, near-spherical, spherical, disk-shaped geometries.

43. The slurry of claim 39, wherein an average length of the microstructures and/or nanostructures is at least twice an average thickness of the microstructures or nanostructures.

44. The slurry of claim 39, wherein a pH is 5-7.5.

45. The slurry of claim 39 comprising a weight ratio of the dispersant to the ceramic powder is 0.01-3%; and a volume ratio of the powder to the total volume of the slurry (also known as the initial solid loading) is 10-90%.

46. A method of fabricating a composite material system comprising:
directional freezing a powder slurry to yield a phase-segregated frozen solvent green body; drying the frozen powder slurry to sublimate the frozen solvent to yield a freeze-dried
porous material (also known as green body in materials science field);
sintering the freeze-dried green body to yield a mechanically robust porous backbone/substrate defining a multiplicity of pores;
infiltrating pores of the backbone with a 0D/1D/2D coating material (MXene) by submerging at least a portion of it in an liquid dispersion of the coating material (single or multiplayer MXene nanosheets);
applying vacuum for 10-15 minutes to reduce/remove the entrapped air from the porous backbone; and keeping the backbone submerged inside the dispersion for a time sufficient (10 minutes to 24 hours) to wet and cover all or at least a portion of the interior pore surfaces; and
drying the wetted porous backbone after removing it from the dispersion to a clean vial to dry for 12 hours under vacuum or placing the wetted substrate inside a freeze-dryer to remove water content, thereby yielding the composite material of 0D/1D/2D material infiltrated porous substrate.

47. The method of claim 46 comprising adjusting the initial solid loading, particle size of solid component of slurry, solvent type, cooling temperature or rate, cooling direction (unidirectional, or multi-directional), annealing temperature and duration (applicable to frozen slurry, enables further pore growth by keeping frozen sample at an elevated temperature, which is lower than the melting point of the solvent) of the freeze-cast slurry before sintering to control a density, size, orientation (direction), and shape of the pores.

48. The method of claim 46, wherein the sintering, which is the process of compacting and forming a solid mass of material by pressure or heat without melting it to the point of liquefaction, occurs at a temperature smaller than the melting temperature of the ceramic powder.

49. A method of making a composite material system comprising:
introducing a dispersion comprising two-dimensional nanoflakes (including MXene, including transition metal carbide, nitrides and carbonitrides) into a substrate having open porosity;
applying vacuum for a time sufficient (10-15 minutes) to reduce/remove the entrapped air from the porous backbone;
submerging at least a portion of the substrate in the dispersion for a time sufficient (10 minutes to 24 hours) to wet and cover all or at least a portion of the interior pore surfaces;
removing the wetted porous substrate from the dispersion; and
drying the wetted porous substrate in clean vial under vacuum or in a freeze-dryer for a time sufficient (10 minutes to 24 hours) to reduce/remove water content, thereby yielding the composite material of 0D/1D/2D material infiltrated porous substrate.

50. The method of claim 49, wherein introducing the 2D material dispersion into the void of substrate comprises positioning the porous substrate in the dispersion.

51. The method of claim 49, wherein introducing the 2D material dispersion into the void of substrate comprises flowing the dispersion through one or more microchannels within the substrate to fill the pores and cover all the pore surfaces inside the substrate.

52. A method of manufacturing a composite material system comprising a 3D arrangement of 0D/1D/2D material network, the method comprising:
fabricating porous backbones (including ceramic, metal, polymer) having controlled porosity using the freeze casting process;
synthesizing 0D/1D/2D material and preparing the dispersion having a desired 0D/1D/2D material concentration and nanoflake size and thickness;
infiltrating pores of backbone with 0D/1D/2D material by submerging it in an aqueous dispersion of 0D/1D/2D material, single or multiplayer MXene nanosheets); and
applying vacuum for 10-15 minutes to remove/reduce the entrapped air from the porous
backbone;
submerging all or at least a portion of the backbone in the 0D/1D/2D material dispersion for
a time sufficient (10 minutes to 24 hours) to wet and cover all or at least a portion of the interior pore surfaces of the backbone;
removing the wetted porous backbone from the 0D/1D/2D material dispersion;
and drying the wetted porous backbone in clean vial under vacuum or in a freeze-dryer for a
time sufficient (10 minutes to 24 hours) to reduce/remove water content, thereby yielding the composite material of 0D/1D/2D material infiltrated porous substrate,
wherein the network's spatial distribution is tuned by the freeze casting parameters, which are the initial solid loading, particle size of solid component of slurry, solvent type, cooling temperature or rate, cooling direction (unidirectional, or multi-directional), annealing temperature and duration (which is applicable to frozen slurry before drying and enables further pore growth by keeping frozen sample at an elevated temperature, which is lower than the melting point of the solvent), sintering temperature and duration.

53. The method of claim 52, wherein adjusting the 0D/1D/2D material MXene infiltration comprises controlling concentration of 0D/1D/2D material MXene dispersion, controlling infiltration duration during which the porous silica substrate is held submerged within 0D/1D/2D material MXene dispersion, number of infiltration cycles that is single infiltration or multiple infiltration processes (which imply infiltration of a sample that was already infiltrated and dried prior to next infiltration step; also the 0D/1D/2D material MXene concentration per infiltration cycle is independently controlled.

54. The method of claim 52, wherein the 0D/1D/2D material MXene infiltrates the porous silica backbone at least to a depth of 5 mm, ensuring coverage of the internal pores that are 5 mm deep inside from the external surface of the backbone.

55. The method of claim 52, wherein the infiltrating comprises single infiltration, meaning the porous backbone is submerged into a 0D/1D/2D material dispersion with controlled concentration only once and dried afterwards to obtain the composite material system.

56. The method of claim 52, wherein the infiltrating comprises multiple infiltration cycles, indicating infiltration of a porous sample that was already infiltrated and dried prior to next infiltration step by repeating the following steps: infiltrating pores of the backbone with 0D/1D/2D material by submerging it in an aqueous dispersion of 0D/1D/2D material; and applying vacuum for a time sufficient (10-15 minutes) to reduce/remove the entrapped air from the porous backbone; and submerging all or at least a portion of the backbone in the 0D/1D/2D material dispersion for a time sufficient (10 minutes to 24 hours) to wet and cover all or at least a portion of the pore surfaces of the backbone; removing the wetted porous backbone from the 0D/1D/2D material dispersion; and drying the wetted porous backbone in clean vial under vacuum or the wetted silica substrate in a freeze-dryer for a time sufficient (10 minutes to 24 hours) to reduce/remove water content, thereby yielding the composite material of 0D/1D/2D material infiltrated porous substrate.

57. The method of claim 52, wherein the 0D/1D/2D material MXene concentration is up to 180 mg/mL (4 vol. % solid loading).

58. The method of claim 52, wherein the MXene viscosity is 0.350 Pas.

59. The method of claim 52, wherein the electrical conductivity of the composite material system consisting of a 3D MXene network on its internal channels is up to 340 S/m.

60. The method of claim 52, wherein the network has anisotropy (the quality of exhibiting properties with different values when measured along axes in different directions) of electrical conductivity because the 0D/1D/2D material infiltrated backbone possesses a directional porosity due to unidirectional freeze casting, which indicates the slurry was frozen along a specific direction and since the internal pores and channels originate from the frozen crystals of the solvent (camphene for this case), the freeze casting yields an anisotropic pore morphology.

61. A method of manufacturing a composite material system comprising a connected 3D network of 0D/1D/2D material, the method comprising:
freeze casting of a powdered solid to yield a porous backbone/substrate having open hierarchical porosity and a controlled porosity and pore size distribution;
submerging the porous structure in a dispersion of 0D/1D/2D material to infiltrate 0D/1D/2D material into pores of the structure to establish the 3D network of 0D/1D/2D material comprising nanoflakes on the internal pore surfaces of porous silica;
removing the wetted porous backbone from the 0D/1D/2D material dispersion;
drying the wetted porous backbone in clean vial under vacuum or a time sufficient (10 minutes to 24 hours) to reduce/remove water content or in a freeze-dryer for a time sufficient to reduce/remove water content, thereby yielding the composite material of 0D/1D/2D material infiltrated porous material system (e.g., MX-PS) system; and
storing the material at 4 °C or lower temperatures in sealed vials until use to minimize oxidation;
wherein the 0D/1D/2D material-to-backbone mass ratio is in the range from greater than 0
up to 10% for single infiltration cycles;
wherein, optionally, repeating the coating step via multiple infiltration cycles (e.g., this ratio may be 25% for a MX-PS sample that is infiltrated with 180 mg/mL MXene concentration by three times).

62. The method of claim 61, wherein the 0D/1D/2D material comprises a MXene, e.g., Ti3C2Tx.

63. The method of any of the foregoing statements, wherein the 0D/1D/2D material dispersion comprises an exfoliated single-layer and a delaminated multilayer of Ti3C2Tx MXene flakes.

64. The method of claim 61, wherein ceramic freeze casting comprises unidirectional freeze casting using a camphene-based solvent to yield the dendritic and hierarchical porosity within the silica structure.

65. The method of claim 61, wherein the dispersion of MXene is infiltrated into the porous silica using capillary flow.

66. The method of claim 61, wherein the 2D MXene flakes conformally coat interior surfaces of an interconnected micropore network within the silica structure without blocking pore access.

67. The method of claim 61, wherein the MXene nanoflakes adhere to both interior surfaces of the silica structure and other MXene nanoflakes.

68. The material of claim 1, wherein the morphology and properties of the internal pore system is related the liquid media or solvent, including but not limited to water, camphene, tert-butyl alcohol, cyclooctane, cyclohexane, dioxane, and dimethyl carbonate.

69. The material of claim 1, wherein the final pore morphology of freeze-cast materials is predicted by dimensionless Jackson alpha-factor, which is determined, inter alia, by the melting point and enthalpy of fusion of the solvent, and describes the crystal growth regime responsible for morphology of solvent crystals formed during solidification; wherein solvents having low Jackson alpha-factor, such as acetone, benzene may create non-faceted, irregularly shaped pore morphologies with rough surfaces; wherein solvents having intermediate Jackson alpha-factor, such as camphene, chloroform,
diethyl ether may create dendritic pore morphologies; and wherein solvents having high Jackson alpha-factor, such as water, methanol, acetonitrile may create faceted and sometimes lamellar pore morphologies with regular shapes and smooth surfaces.

70. The material of claim 1, wherein the porous substrate is fabricated via suspension-based freeze casting of polymers, wherein the solid component of the initial slurry is not soluble in the selected liquid component, such as polyether ether ketone (PEEK) and camphene, or polytetrafluoroethylene (PTFE) and camphene, or polyethylene (PE) and water, or polypropylene (PP) and water; wherein the initial solid particles are suspended within the liquid media with appropriate surfactants that help with particle dispersion by prevent aggregation and/or precipitation; wherein the steps of freeze casting, i.e., slurry preparation, solidification, freeze drying/sublimation, sintering, are performed similarly to those used in the freeze casting of ceramics or metals; and wherein the sintering mechanically strengthens the final structure.

71. The material of claim 1, wherein the porous substrate is fabricated via solution-based freeze casting of polymers, wherein the solid component of initial slurry is soluble in the selected solvent, such as polystyrene (PS) and camphene, polyvinyl Chloride (PVC) and camphene, or polyethylene glycol and water, or polyvinyl alcohol and water; wherein the first steps of freeze casting or slurry preparation, is slightly modified, such that a solution is prepared instead of a slurry; wherein the intermediate steps of freeze casting or solidification, freeze drying/sublimation, are performed similarly to those used in the freeze casting of ceramics or metals; wherein the final porous polymer substrate is obtained after freeze drying; and wherein the sintering is optionally applied to provide additional mechanical strength to the final porous polymer structure.
